(19) United States
(12) Patent Application Publication
(10) Pub. No.: US 2026/0084648 A1
(43) Pub. Date: Mar. 26, 2026

(54) ELECTRONIC CONTROL DEVICE, FUNCTION RESTRICTION MANAGEMENT SYSTEM, FUNCTION RESTRICTION MANAGEMENT METHOD, AND STORAGE MEDIUM THEREOF

(71) Applicant: Denso Corporation, Kariya-city (JP)

(72) Inventors: Koichi TAKAGI, Kariya-city (JP); Toshiaki Horai, Kariya-city (JP); Shiori Maneyama, Kariya-city (JP)

(21) Appl. No.: 19/399,344

(22) Filed: Nov. 24, 2025

Related U.S. Application Data
(63) Continuation of application No. PCT/JP2024/016888, filed on May 2, 2024.

(30) Foreign Application Priority Data
May 30, 2023 (JP) 2023-088684

(51) Int. Cl. B60R 25/01; B60R 25/102; B60R 25/24

(52) U.S. Cl. CPC B60R 25/01; B60R 25/102; B60R 25/24

(57) ABSTRACT

An electronic control device includes at least one of (i) a circuit and (ii) a processor with a memory storing computer program code executable by the processor. The at least one of the circuit and the processor configured to cause the electronic control device to: activate a function restriction against vehicle theft; set a priority based on an operation type corresponding to an activation operation or a deactivation operation of the function restriction; maintain the set priority; update the maintained priority when a current priority indicated by a function restriction activation request is higher than the maintained priority; determine, based on the priority, whether the activated function restriction can be deactivated; and deactivate the function restriction, which has been activated, in response to determining that the function restriction can be deactivated.

### CROSS REFERENCE TO RELATED APPLICATIONS

The present application is a continuation application of International Patent Application No. PCT/JP2024/016888 filed on May 2, 2024, which designated the U.S. and claims the benefit of priority from Japanese Patent Application No. 2023-088684 filed on May 30, 2023. The entire disclosures of all of the above applications are incorporated herein by reference.

### TECHNICAL FIELD

The present disclosure relates to an electronic control device, a function restriction management system, a function restriction management method, and a storage medium storing function restriction management program.

### BACKGROUND

Conventionally, anti-theft devices are provided to prevent theft of vehicles. There has been known a system that allows a vehicle to automatically travel when the vehicle is located within a predetermined area, such as a valet parking lot. However, when the vehicle is located outside the predetermined area, travel of the vehicle is restricted, thereby preventing the vehicle from leaving the predetermined area.

### SUMMARY

According to an aspect of the present disclosure, a function restriction management method includes: activating a function restriction against vehicle theft; setting a priority based on an operation type corresponding to an activation operation or a deactivation operation of the function restriction; maintaining the set priority; and updating the maintained priority when a current priority indicated by a function restriction activation request is higher than the maintained priority. The function restriction management method may further include: determining, based on the priority, whether the activated function restriction can be deactivated; and deactivating the function restriction, which has been activated, in response to determining that the activated function restriction can be deactivated.

### BRIEF DESCRIPTION OF DRAWINGS

The present disclosure will become apparent from the following detailed description made with reference to the accompanying drawings. In the drawings:

FIG. 1 is a functional block diagram showing an overall configuration according to a first embodiment;

FIG. 2 is a functional block diagram of an electronic control unit;

FIG. 3 is a diagram showing a route corresponding to a function restriction activation operation or a function restriction deactivation operation;

FIG. 4 is a diagram showing a relationship between priority and possibility of deactivation;

FIG. 5 is a flowchart showing a function restriction activation process according to a first route;

FIG. 6 is a flowchart showing a function restriction activation process according to a first route;

FIG. 7 is a flowchart showing a function restriction activation process according to a first route;

FIG. 8 is a flowchart showing a function restriction activation process according to a first route;

FIG. 9 is a flowchart showing a function restriction activation process according to a second route;

FIG. 10 is a flowchart showing a function restriction activation process according to a second route;

FIG. 11 is a flowchart showing a function restriction activation process according to a second route;

FIG. 12 is a flowchart showing a function restriction activation process according to a second route;

FIG. 13 is a flowchart showing a function restriction activation process according to a third route;

FIG. 14 is a flowchart showing a function restriction activation process according to a third route;

FIG. 15 is a flowchart showing a function restriction deactivation process;

FIG. 16 is a diagram showing a transition of a display accompanying activation of function restriction according to a first route;

FIG. 17 is a diagram showing a transition of a display accompanying activation of function restriction according to a first route;

FIG. 18 is a diagram showing a transition of a display accompanying activation of function restriction according to a first route;

FIG. 19 is a diagram showing a transition of a display accompanying activation of function restriction according to a first route;

FIG. 20 is a diagram showing a transition of a display accompanying deactivation of function restriction according to a first route;

FIG. 21 is a diagram showing a transition of a display accompanying deactivation of function restriction according to a first route;

FIG. 22 is a diagram showing a transition of a display accompanying deactivation of function restriction according to a first route;

FIG. 23 is a diagram showing a transition of a display accompanying deactivation of function restriction according to a first route;

FIG. 24 is a diagram showing a transition of a display accompanying activation of function restriction according to a second route;

FIG. 25 is a diagram showing a transition of a display accompanying activation of function restriction according to a second route;

FIG. 26 is a diagram showing a transition of a display accompanying activation of function restriction according to a second route;

FIG. 27 is a diagram showing a transition of a display accompanying activation of function restriction according to a second route;

FIG. 28 is a diagram showing a transition of a display accompanying deactivation of function restriction according to a second route;

FIG. 29 is a diagram showing a transition of a display accompanying deactivation of function restriction according to a second route;

FIG. 30 is a diagram showing a transition of a display accompanying deactivation of function restriction according to a second route;

FIG. 31 is a diagram showing a transition of a display accompanying deactivation of function restriction according to a second route;

FIG. 32 is a diagram showing a transition of a display accompanying activation of function restriction according to a third route;

FIG. 33 is a diagram showing a transition of a display accompanying activation of function restriction according to a third route;

FIG. 34 is a diagram showing a transition of a display accompanying activation of function restriction according to a third route;

FIG. 35 is a diagram showing a transition of a display accompanying deactivation of function restriction according to a third route;

FIG. 36 is a diagram showing a transition of a display accompanying deactivation of function restriction according to a third route;

FIG. 37 is a diagram showing a transition of a display accompanying deactivation of function restriction according to a third route;

FIG. 38 is a flowchart showing a function restriction deactivation process according to a second embodiment;

FIG. 39 is a flowchart showing a function restriction deactivation process according to a third embodiment; and

FIG. 40 is a flowchart showing a function restriction deactivation process.

### DETAILED DESCRIPTION

In recent years, there are functions that prevent vehicle theft and further limit, by activating vehicle function restriction, functions of vehicle to reduce damage of vehicle theft. When the vehicle theft is resolved, vehicle function restriction is deactivated. However, even though an owner of vehicle activates function restriction, if the thief who stole the vehicle can deactivate the function restriction, the function restriction will not be effective anymore against the theft of vehicle.

According to an aspect of the present disclosure, an electronic control device includes at least one of (i) a circuit and (ii) a processor with a memory storing computer program code executable by the processor. The at least one of the circuit and the processor configured to cause the electronic control device to implement a function restriction activation unit, a priority setting unit, a priority maintaining unit, a priority update unit, a deactivation possibility determination unit, and a function restriction deactivation unit. The function restriction activation unit is configured to activate a function restriction against vehicle theft. The priority setting unit is configured to set a priority based on an operation type corresponding to an activation operation or a deactivation operation of the function restriction. The priority maintaining unit is configured to maintain the priority set by the priority setting unit. The priority update unit is configured to update the priority maintained by the priority maintaining unit when a current priority indicated by a function restriction activation request is higher than the priority maintained by the priority maintaining unit. The deactivation possibility determination unit is configured to determine, based on the priority, whether the function restriction activated by the function restriction activation unit can be deactivated. The function restriction deactivation unit is configured to deactivate the function restriction, which has been activated by the function restriction activation unit, on condition that the deactivation possibility determination unit determines that the function restriction can be deactivated.

Whether the function restriction can be deactivated is determined based on the priority, and the function restriction is deactivated in response that the deactivation of function restriction is determined to be allowed. By setting the priority for determining whether the function restriction can be deactivated, it is possible to prevent a situation in which the thief who stole a vehicle can deactivate the function restriction, which has been activated by the owner of the stolen vehicle. With this configuration, the intended effect of function restriction activated against vehicle theft can be appropriately obtained.

The following will describe embodiments of the present disclosure with reference to the accompanying drawings. In the embodiments to be described below, explanations of configurations that overlap with the preceding embodiments will be omitted.

### first Embodiment

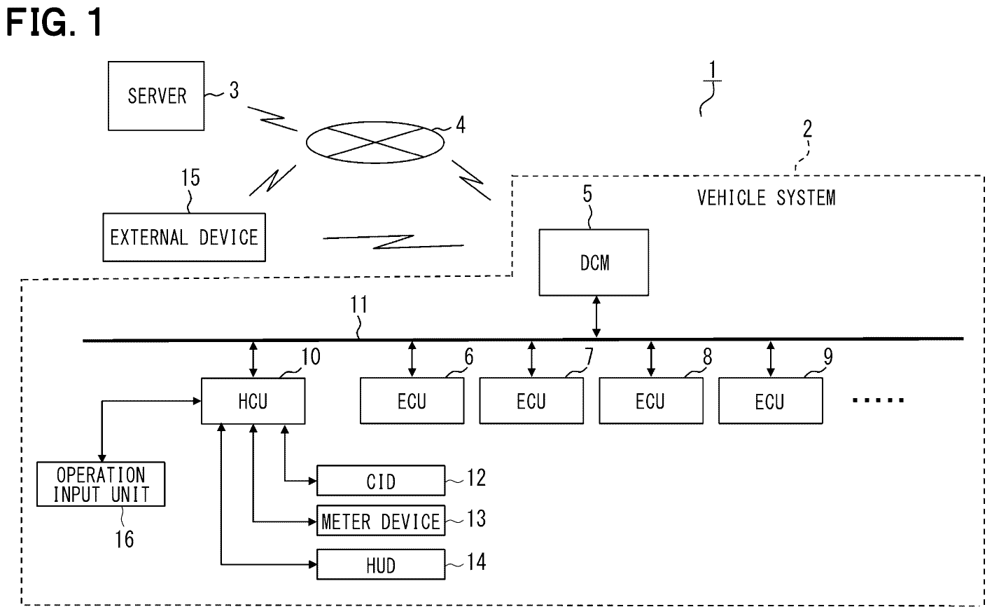

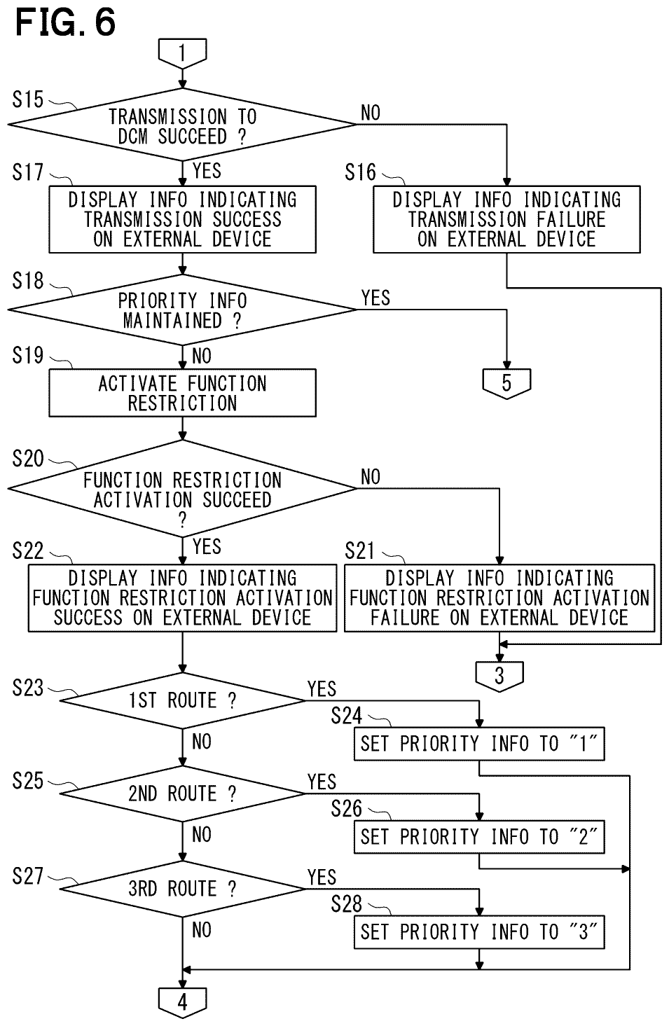

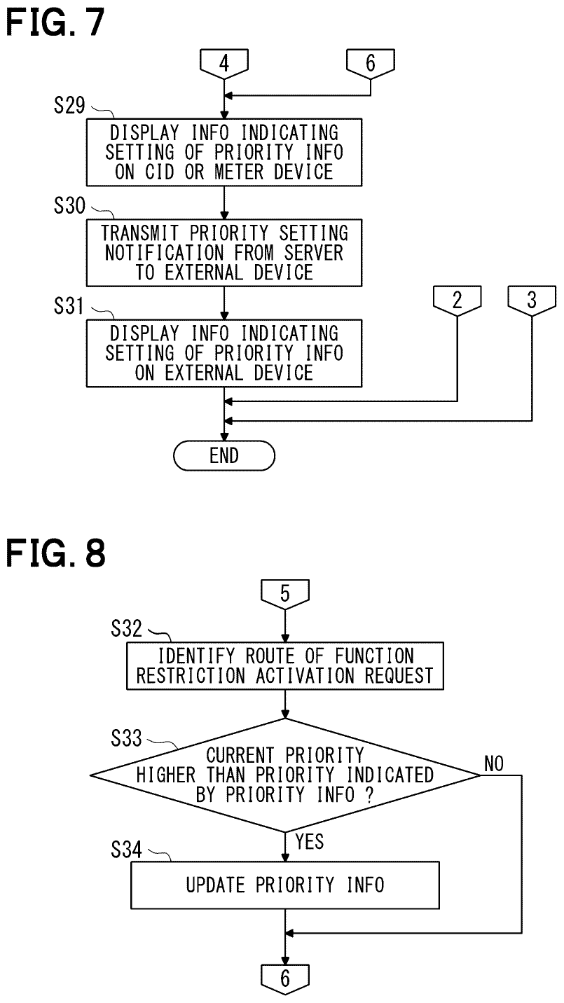

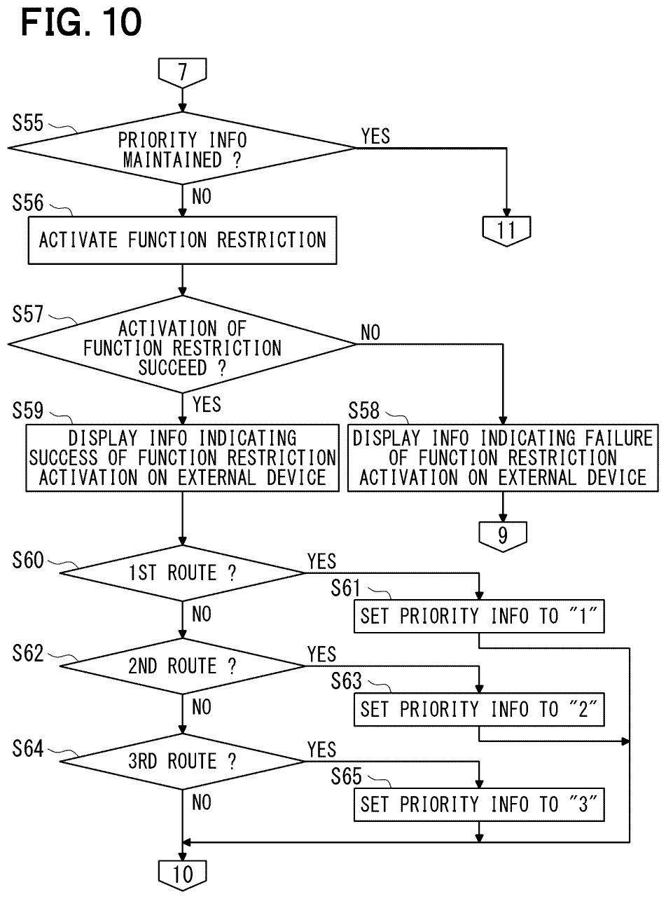

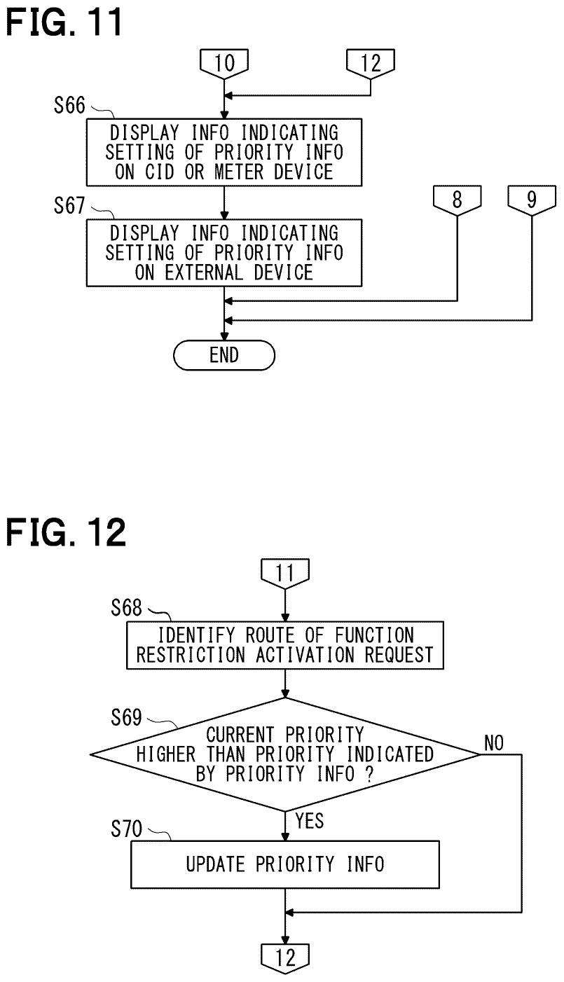

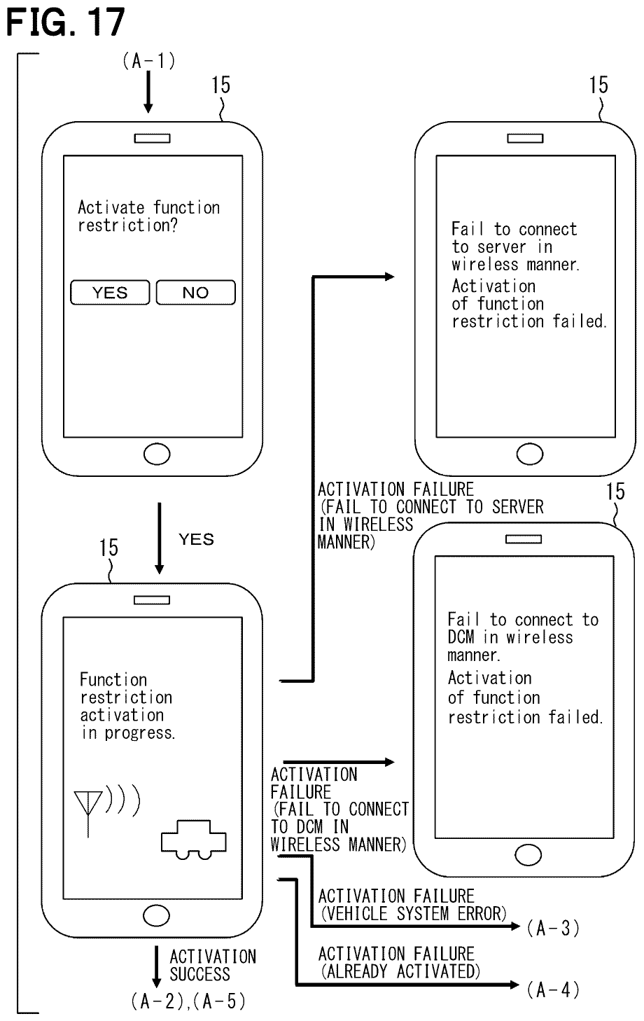

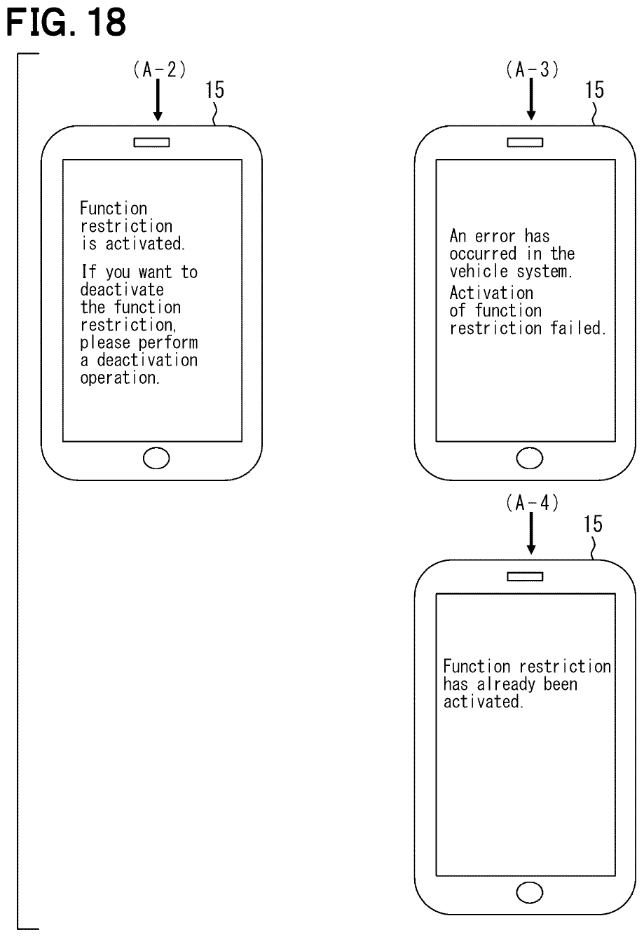

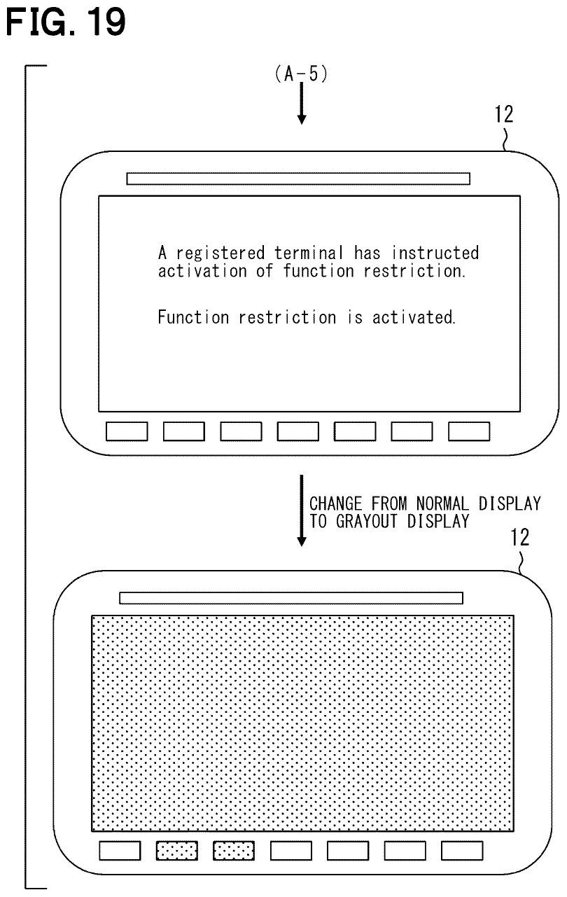

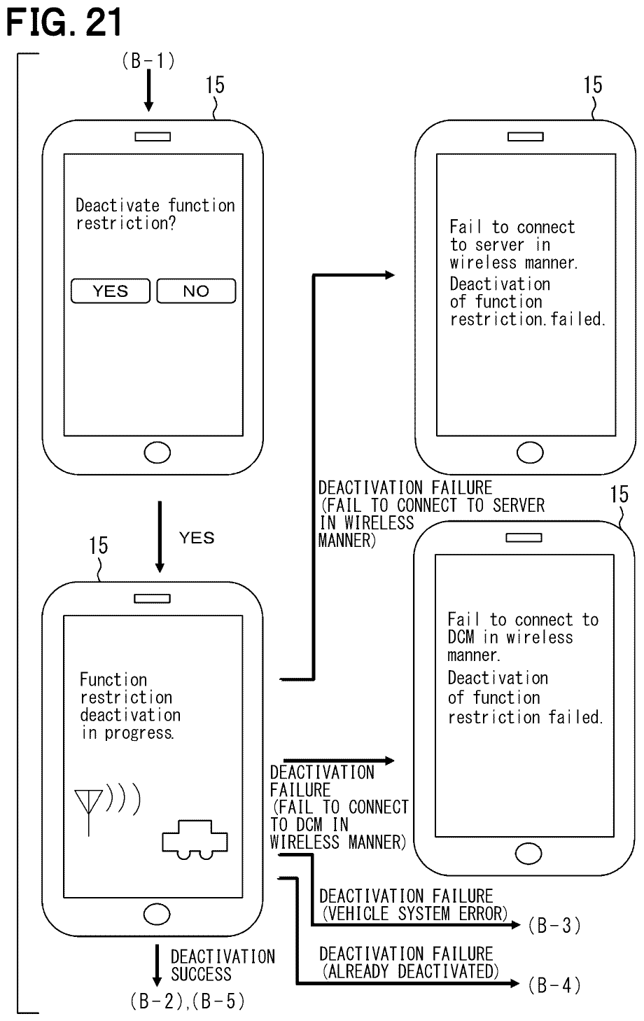

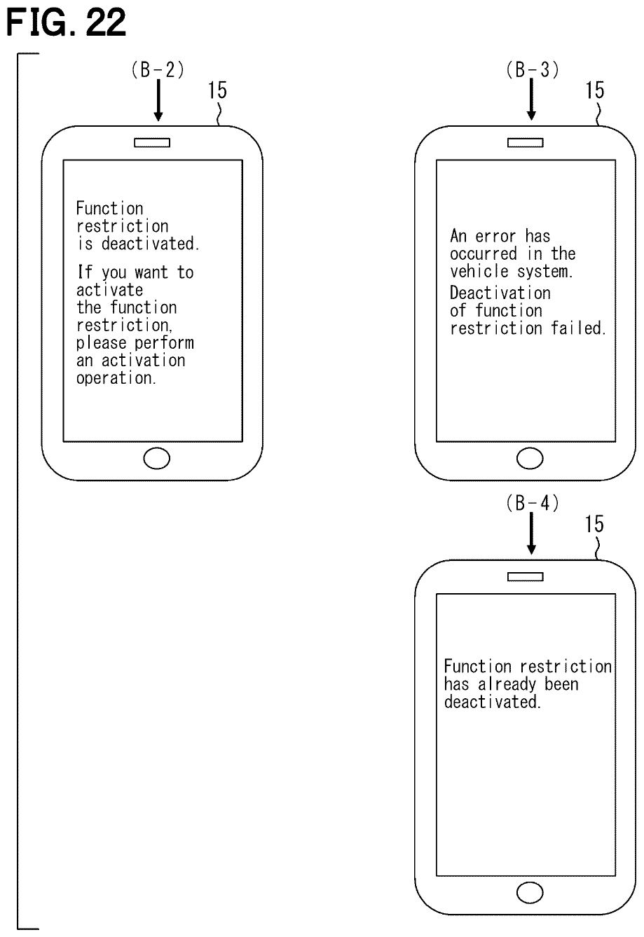

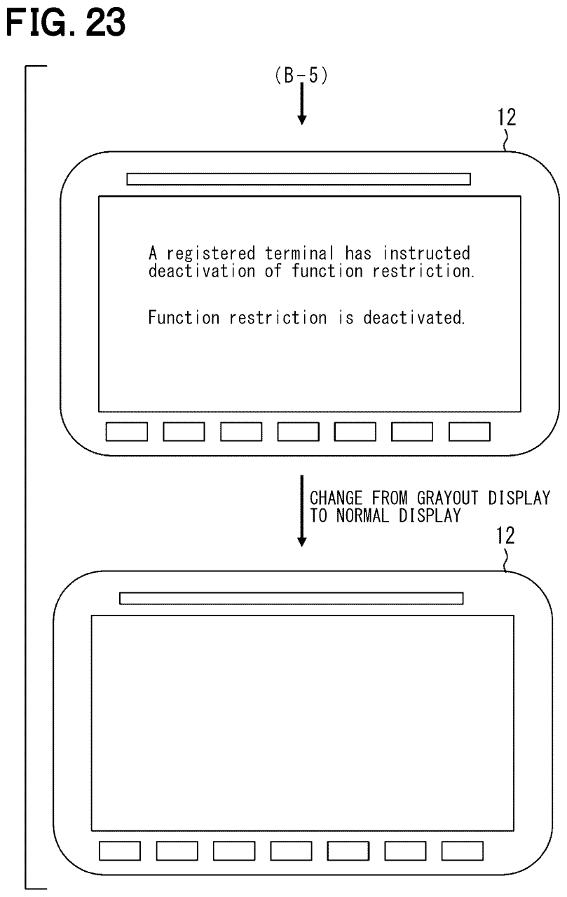

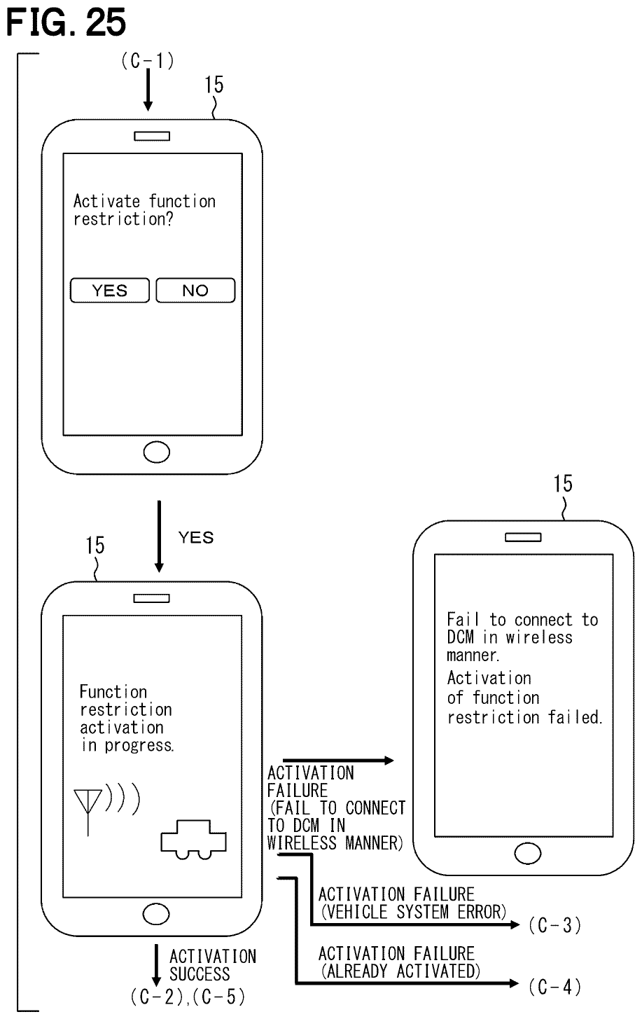

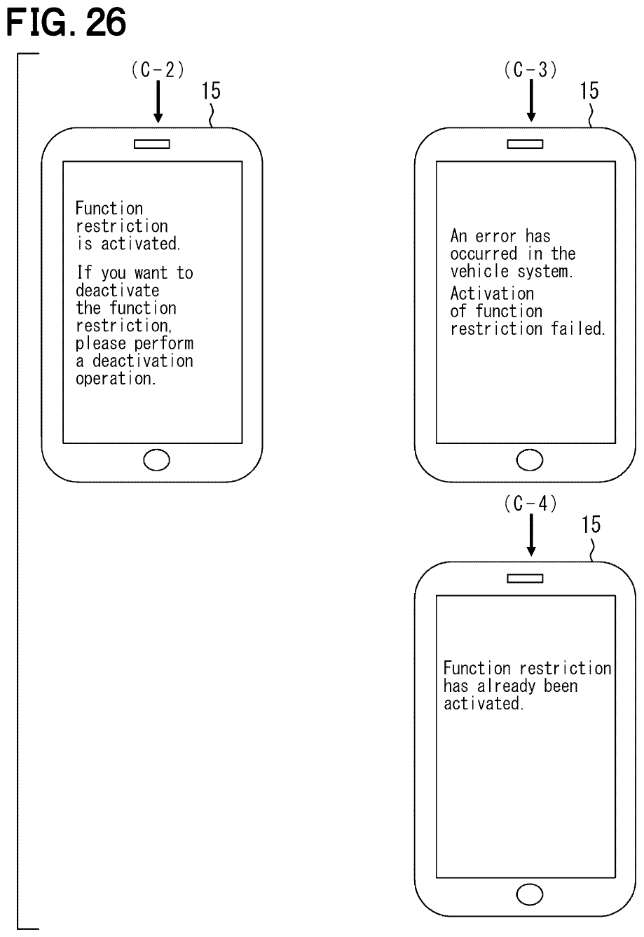

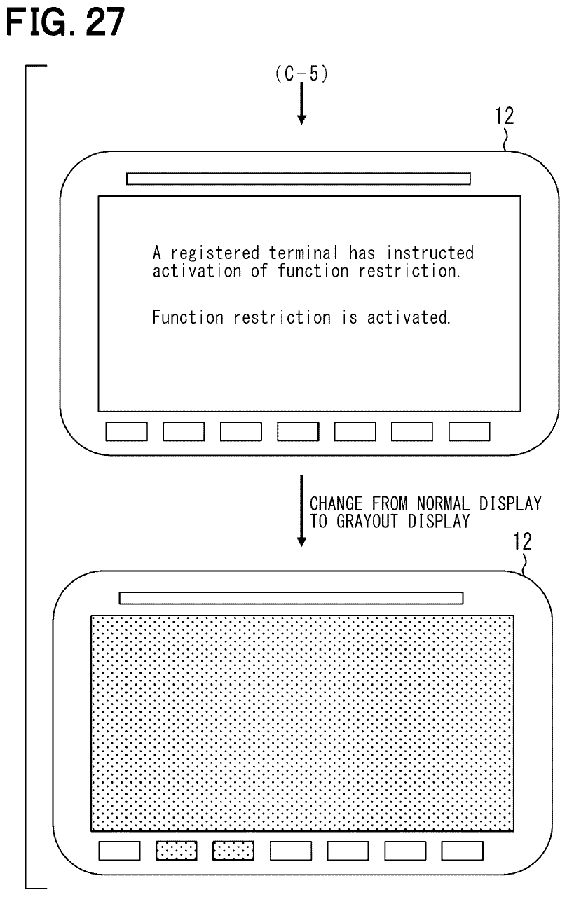

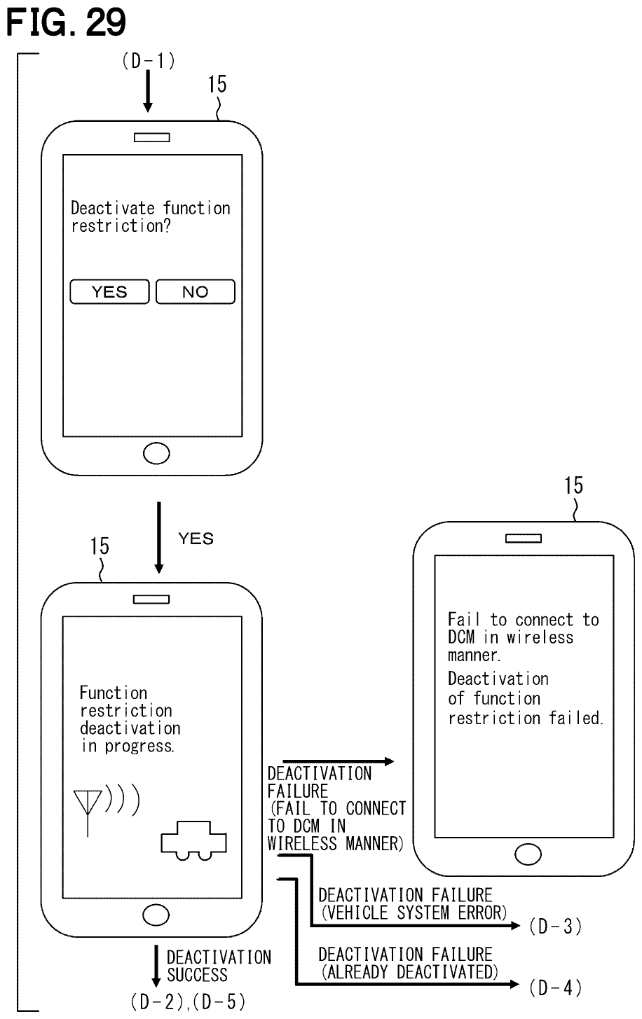

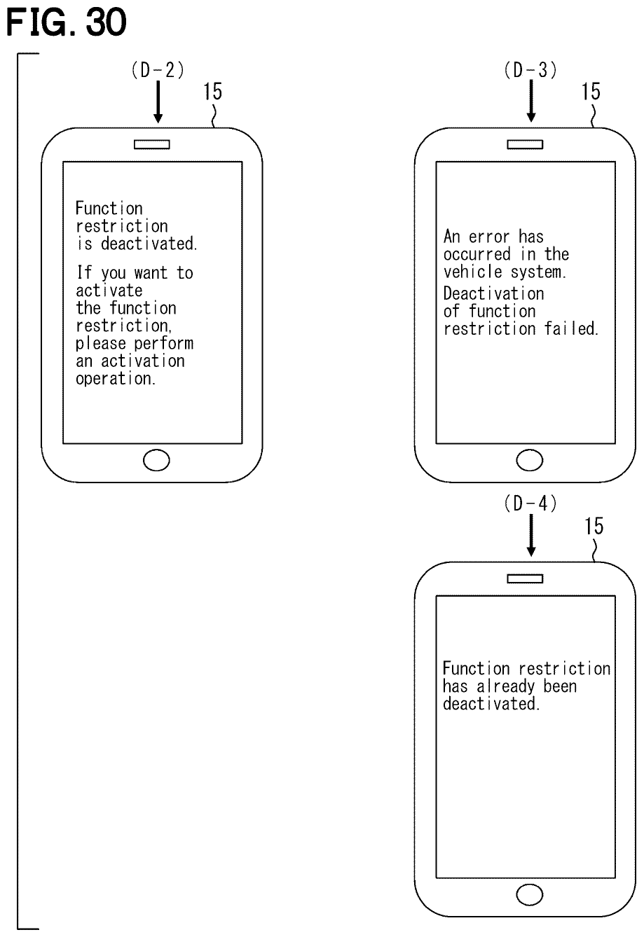

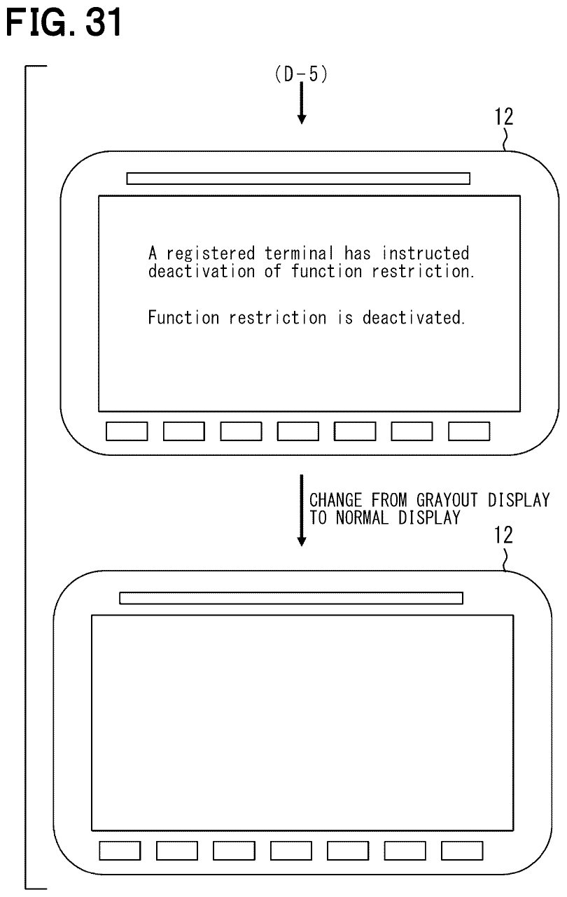

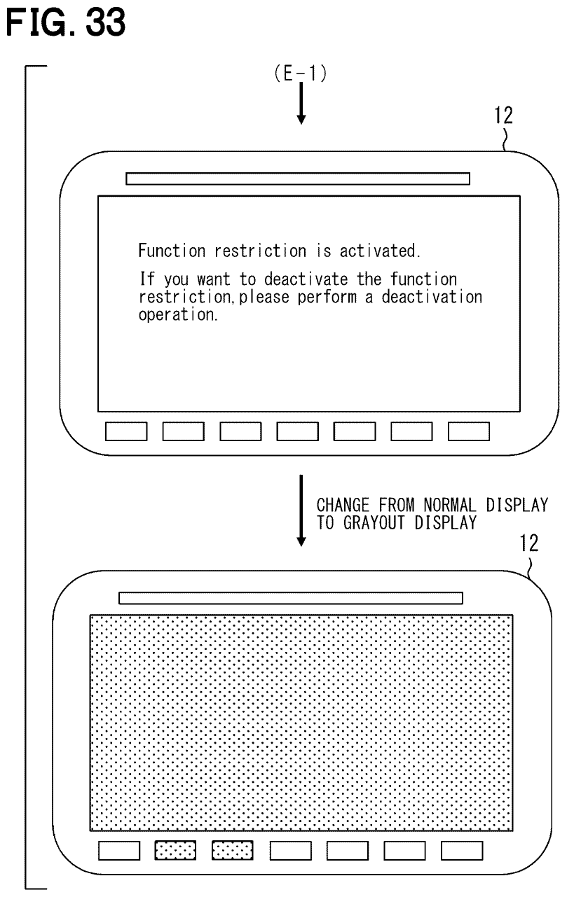

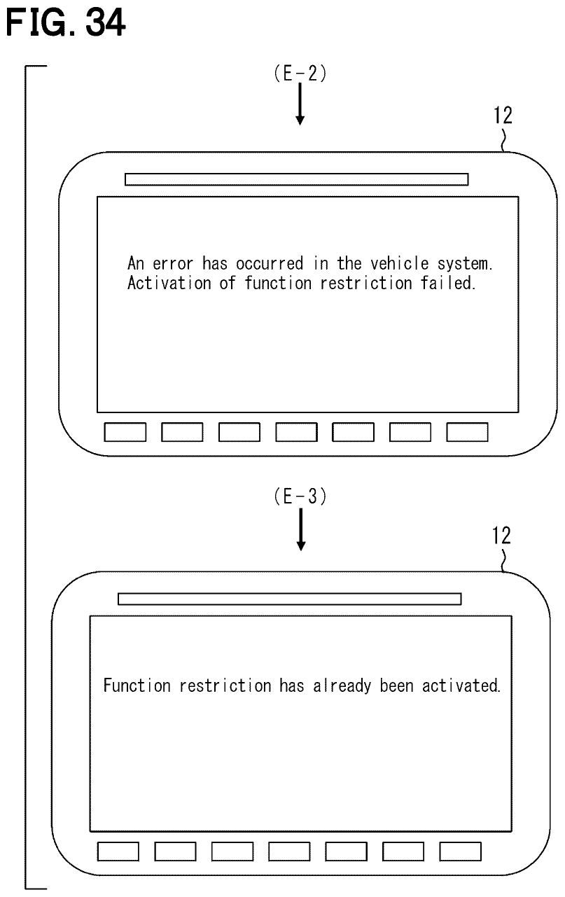

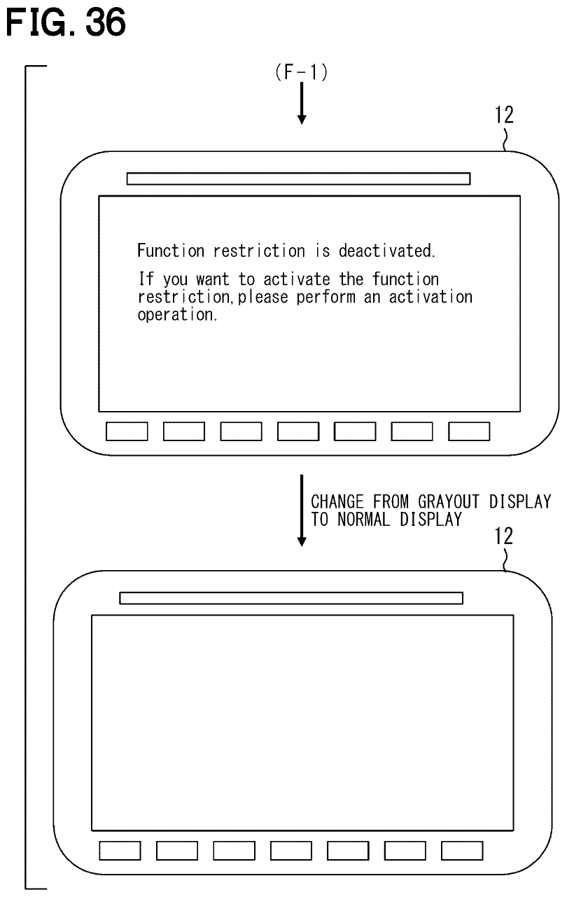

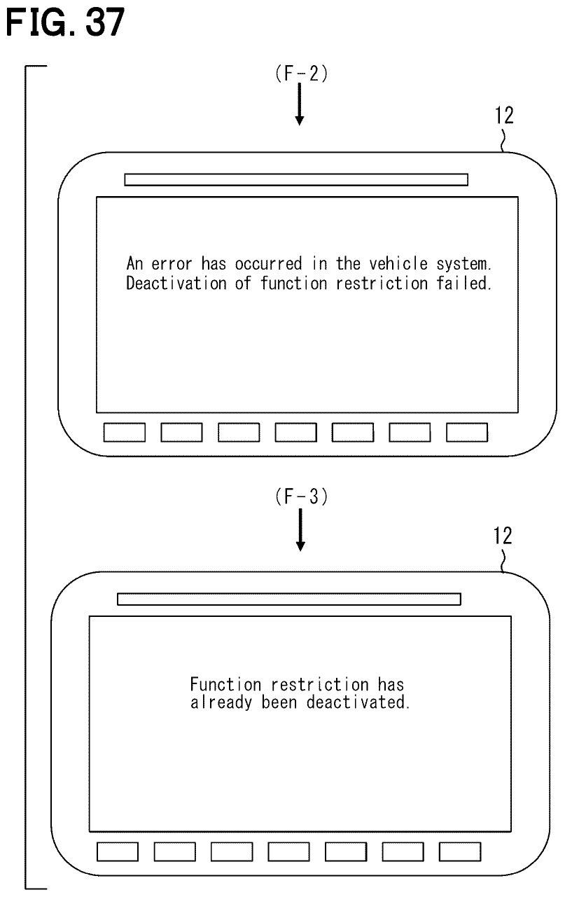

The following will describe a first embodiment with reference to FIG. 1 to FIG. 37. A function restriction management system 1 includes a vehicle system 2, which is mounted on a vehicle, and a server 3, which is located outside the vehicle. The vehicle system 2 and the server 3 are configured to communicate data with each other via a communication network 4. The vehicle system 2 includes a vehicle-mounted communication device 5, electronic control units (ECUs) 6, 7, 8, 9, a human machine interface (HMI) control unit 10, and an in-vehicle network 11. The HMI control unit 10 is also referred to as HCU. The components of the vehicle system 2 are configured to communicate data with each other via the in-vehicle network 11. The vehicle-mounted communication device 5 is also referred to as data communication module (DCM).

The in-vehicle network 11 may be provided by a controller area network (CAN, registered trademark). The in-vehicle network 11 may be provided by FlexRay (registered trademark), CXPI (Clock Extension Peripheral Interface, registered trademark), Ethernet (registered trademark), or the like. In the present embodiment, four ECUs 6 to 9 are connected to the in-vehicle network 11. Alternatively, the number of ECUs connected to the in-vehicle network 11 may be properly set to a different number. The number of in-vehicle networks 11 may be properly set.

The DCM 5 is wirelessly connected to the server 3 via the communication network 4, and is also wirelessly connected to an external device 15, which will be described later, without using the communication network 4. The ECU 6 is configured to control the activation and deactivation of function restriction against theft of the vehicle. The functions against theft of vehicle causes disadvantages to the owner of stolen vehicle, such as functions related to driving, functions related to charges for using paid services or downloading paid applications, or the like. The software application that provides a service is also referred to as app.

Activation of function restriction means enabling the corresponding function restriction, and prohibiting the use of all or part of the functions. For example, when the function against theft is a function related to driving, the engine start or motor start may be prohibited or the driving speed may be limited to a low speed. For example, when the function against theft involves charges for use of paid services or downloading of paid applications, the use of paid services or the downloading of paid applications may be prohibited in whole or in part.

Deactivation of function restriction means invalidating the function restriction, and permitting the use of all or part of the functions that were previously prohibited. For example, when the function against theft is a function related to driving, the engine start or motor start may be permitted again or restriction set on driving speed may be deactivated. For example, when the function against theft is a function that involves charges for using a paid service or downloading a paid application, the use of paid service or downloading of paid application may be permitted again in whole or in part.

The owner of a stolen vehicle can perform an operation to activate the function restriction on the stolen vehicle, so that even if the thief who stole the vehicle performs an operation, such as starting the engine or motor, the start of engine or motor is prohibited by the activated function restriction. When the thief who stole the vehicle performs an operation, such as using a paid service that requires payment or downloading of a paid application that requires payment, by activating the function restriction, the thief can be prohibited from using the paid service or downloading the paid application. After the theft is resolved, the vehicle owner can perform an operation to deactivate the function restriction. By deactivating the function restriction on the vehicle after the theft has been resolved, it is possible to permit again engine start or motor start. Similarly, use of paid service or download of paid application can be permitted again. The ECU 6 is connected to a battery power source (+B) supplied by a vehicle battery, and can operate even when the vehicle power supply is turned off.

The ECU 7 may be a device that controls a driving system. The ECU 8 may be a device that controls an Advanced Driving Assistant System (ADAS) system. The ECU 9 may be a device that controls a multimedia system.

The HCU 10 is connected to a center information display (hereinafter referred to as CID) 12, a meter device 13, and a head-up display (hereinafter referred to as HUD) 14. The CID 12 is disposed in front of the driver's seat and displays, for example, a map used for a navigation function, a camera image related to a parking assist function, audio information related to audio, air conditioning information related to air conditioning, and the like. The meter device 13 is disposed in front of the driver's seat, includes various indicators, and displays a vehicle speed, a shift position, the remaining amount of fuel, a warning, and the like. The HUD 14 projects information such as a vehicle speed, a shift position, and route guidance on the windshield as a virtual image in front of the driver's seat. Similar to the ECU 6, the HCU 10 is connected to the battery power source (+B) supplied by the vehicle battery, and can operate even when the vehicle power supply is turned off.

The external device 15 is capable of performing data communication with the vehicle system 2 by wirelessly connecting to the DCM 5 via the communication network 4. The external device 15 is a portable information terminal, such as a smartphone or a tablet terminal that can be carried by the occupant. The external device is a terminal that can be used by the occupant inside or outside the vehicle.

The HCU 10 is connected to an operation input unit 16 that can be operated by the occupant to receive an operation input by the user. The operation input unit 16 may be implemented as a touch panel of the CID 12, a steering switch disposed on the steering wheel, or the like.

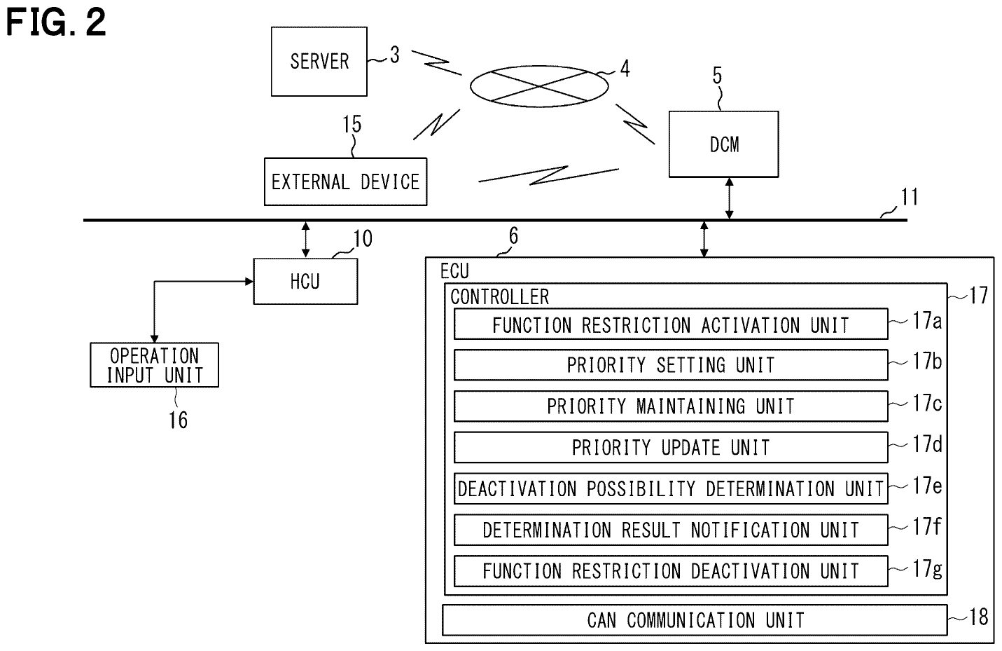

As shown in FIG. 2, the ECU 6 includes a controller 17 and a CAN communication unit 18. The controller 17 is implemented by a microcomputer, which includes a central processing unit (CPU), a read only memory (ROM), a random access memory (RAM), and an input output interface (I/O). A function provided by the controller 17 can be provided by software stored in a non-transitory tangible storage medium and a computer that executes the software, only software, only hardware, or a combination of software and hardware. For example, when the controller 17 is provided by an electronic circuit in hardware manner, the controller 17 can be provided by a digital circuit including a large number of logic circuits or can be provided by an analog circuit. When the controller 17 executes the program stored in the non-transitory tangible storage medium, a process corresponding to the program is executed, and a method corresponding to the program is executed.

The CAN communication unit 18 controls transmission and reception of CAN signals to and from the in-vehicle network 11.

The controller 17 includes a function restriction activation unit 17a, a priority setting unit 17b, a priority maintaining unit 17c, a priority update unit 17d, a deactivation possibility determination unit 17e, a determination result notification unit 17f, and a function restriction deactivation unit 17g. The units 17a to 17g constitute a function restriction management program.

The function restriction activation unit 17a sets function restriction against vehicle theft. The functions to be restricted may be selectable in advance by the vehicle owner, or may be preset when the vehicle is shipped from the factory or sold. For example, when setting the function restriction related to driving, the function restriction activation unit 17a transmits a function restriction activation signal to the ECU that controls engine start, the ECU that controls motor start, the ECU that controls driving, and prohibits engine start or motor start or limits the driving speed to a predetermined low speed as described above. The priority setting unit 17b sets a priority, which will be described later, based on an operation type corresponding to the operation for activating or deactivating the function restriction. The operation type will be described later.

When the priority is set by the priority setting unit 17b, the priority maintaining unit 17c maintains the set priority as priority information. The priority update unit 17d updates the priority information maintained by the priority maintaining unit 17c. When the priority information is updated by the priority update unit 17d, the priority maintaining unit 17 maintains the updated priority information. Details of priority will be described later.

The deactivation possibility determination unit 17e determines whether the function restriction activated by the function restriction activation unit 17a can be deactivated based on the priority corresponding to operation type maintained by the priority maintaining unit 17c. When the deactivation possibility determination unit 17e determines the deactivation possibility of function restriction, the determination result notification unit 17f notifies the determination result of deactivation possibility.

When the deactivation possibility determination unit 17e determines that deactivation of function restriction is not permitted, the function restriction deactivation unit 17g does not deactivate the function restriction activated by the function restriction activation unit 17a. When the deactivation possibility determination unit 17e determines that the function restriction can be deactivated, the function restriction deactivation unit 17g deactivates the function restriction activated by the function restriction activation unit 17a. For example, in a case where the function restriction deactivation unit 17g deactivates the function restriction related to driving, the function restriction deactivation unit 17g sends a function restriction deactivation signal to the ECU that controls engine start, the ECU that controls motor start, or the ECU that controls driving, and permits engine start or motor start or deactivates driving speed restriction, as described above.

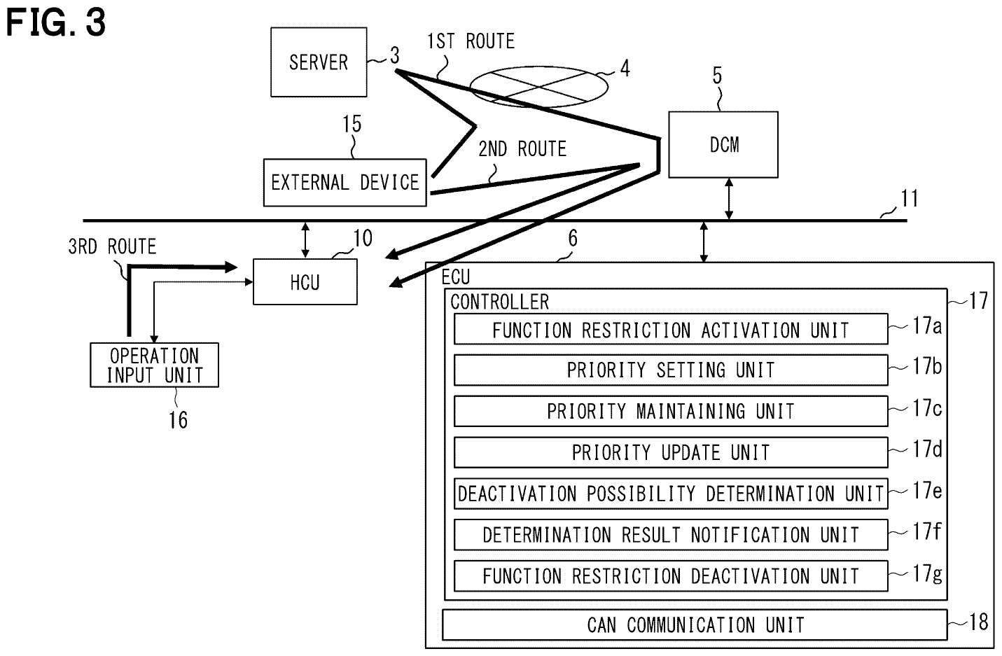

The following will describe the operation type corresponding to the activation operation or the deactivation operation. As shown in FIG. 3, there are three types of operations for activating or deactivating the function restriction. First is an operation via communication from the external device 15 through the communication network 4 (hereinafter, this operation may be referred to as an operation via the first route), second is an operation via short-range wireless communication from the external device 15 (hereinafter, this operation may be referred to as an operation via the second route), and third is an operation from the operation input unit 16 (hereinafter, this operation may be referred to as an operation via the third route). The short-range wireless communication is a communication method in which the external device 15 and the DCM 5 directly perform wireless communication via, such as Bluetooth (registered trademark) or Wi-Fi (registered trademark). When the DCM 5 is configured to be connectable via a wire, the second route is a communication method in which the external device 15 and the DCM 5 directly perform wired communication via a wire, for example, a USB (Universal Serial Bus) interface. Each operation will be explained below.

The operation via the first route is an operation in which the vehicle owner operates the external device 15 to send a function restriction activation request or a function restriction deactivation request from the external device 15 to the HCU 10 of the vehicle system 2 via the server 3. A request to activate or deactivate the function restriction is sent from the external device 15 to the HCU 10 via the server 3. Thus, user authentication is performed in three stages of the external device 15, the server 3, and the vehicle system 2. In this case, it is assumed that the vehicle owner notices the theft of vehicle some time after getting out of the vehicle, and that the external device 15 is unable to communicate with the DCM 5 by short-range wireless communication.

For example, when the owner of vehicle leaves the parking spot after completion of parking and returns to the parking spot and notices that the vehicle that should have been parked is not there, the owner operates the external device 15 to wirelessly connect to the server 3 and causes the external device 15 to transmit a function restriction activation request to the server 3. When the server 3 receives the function restriction activation request from the external device 15, the server 3 transmits the received function restriction activation request to the DCM 5, which is associated, in advance, with the transmission source external device 15 of the function restriction activation request. When the DCM 5 receives the function restriction activation request from the server 3, the DCM 5 transmits the received function restriction activation request to the HCU 10. That is, in the operation for activating the function restriction via the first route, the function restriction activation request is transmitted from the external device 15 to the HCU 10 via the server 3. The above describes the operation for activating function restriction, but the operation for deactivating function restriction is similar. When deactivating the function restriction via the first route, a function restriction deactivation request is sent from the external device 15 to the HCU 10 via the server 3. The operation via the first route involves three stages of user authentication, and therefore has the highest degree of authentication accuracy.

The operation via the second route is an operation in which the vehicle owner operates the external device 15 to send a function restriction activation request or a function restriction deactivation request from the external device 15 to the HCU 10 of the vehicle system 2 without going through the server 3. A request to activate or deactivate the function restriction is sent from the external device 15 to the HCU 10 without going through the server 3. Thus, user authentication is performed in two stages of the external device 15 and the vehicle system 2. In this case, it is assumed that the vehicle is stolen immediately after the owner parks or gets out of the vehicle, and that the external device 15 is capable of performing the short-range wireless communication with the DCM 5.

For example, when the vehicle owner is threatened after parking and getting out of the vehicle, the owner operates the external device 15 to cause the external device 15 to transmit a function restriction activation request to the DCM 5. When the DCM 5 receives the function restriction activation request from the external device 15, the DCM 5 transmits the received function restriction activation request to the HCU 10. That is, in the operation for activating the function restriction via the second route, a function restriction activation request is sent from the external device 15 to the HCU 10 without going through the server 3. The above describes the operation for activating function restriction, but the operation for deactivating function restriction is similar. When deactivating function restriction via the second route, a request for deactivating function restriction is sent from the external device 15 to the HCU 10 without going through the server 3. In the operation via the second route, user authentication is performed in two stages. Thus, the accuracy of authentication has second highest degree, that is, second only to the operation via the first route. For example, the vehicle owner may perform an operation to activate the function restriction via the second route, and then perform an operation to activate the function restriction via the first route. By performing an operation to activate the function restriction via the second route and then performing an operation to activate the function restriction via the first route, it is possible to increase the accuracy of authentication.

The operation via the third route is an operation in which the vehicle owner operates the operation input unit 16 to directly transmits a function restriction activation request or a function restriction deactivation request from the operation input unit 16 to the HCU 10. A request to activate or deactivate the function restriction is sent from the operation input unit 16 to the HCU 10, so that user authentication is performed in one step, that is, in the vehicle system 2. In this case, for example, it is assumed that the vehicle is stolen before the vehicle owner gets out of the vehicle, and that the operation input unit 16 is operable.

For example, when the vehicle owner is threatened before getting out of the vehicle, the owner operates the operation input unit 16 to send a function restriction activation request from the operation input unit 16 to the HCU 10. That is, a function restriction activation request is sent directly from the operation input unit 16 to the HCU 10. The above describes the operation for activating the function restriction, but the operation for deactivating the function restriction is similar. When deactivating the function restriction via the third route, a request for deactivating function restriction is sent directly from the operation input unit 16 to the HCU 10. The third route involves a single step of user authentication, and therefore has the lowest degree of authentication accuracy. For example, the vehicle owner may perform an operation to activate the function restriction via the third route, and then perform an operation to activate the function restriction via the first route or an operation to activate the function restriction via the second route. The accuracy of authentication can be improved by performing an operation to activate the function restriction via the third route, and then performing an operation to activate the function restriction via the first route or the second route. For example, the owner of vehicle may park the vehicle and operate the operation input unit 16 to send a function restriction activation request from the operation input unit 16 to the HCU 10 for preventive safety reasons before getting out of the vehicle, not just in cases where the owner has been threatened.

As described above, since the function restriction activation request and the function restriction deactivation request are aggregated at the HCU 10 regardless of the communication route, the priority setting unit 17b obtains, from the HCU 10, information related to the route of function restriction activation request or the function restriction deactivation request. When the priority setting unit 17b acquires information about the route from the HCU 10, the priority setting unit 17b sets a priority corresponding to one of three routes via which the activation or deactivation operation of the function restriction is performed. The priority setting unit 17b sets the priority of the first route to “1”, the priority of the second route to “2”, and the priority of the third route to “3”. Here, the smaller the priority number, the higher the priority and the request should be more prioritized, and the larger the priority number, the lower the priority and the request should be less prioritized. When the priority is set by the priority setting unit 17b in the above-described manner, the priority maintaining unit 17c maintains the set priority as priority information.

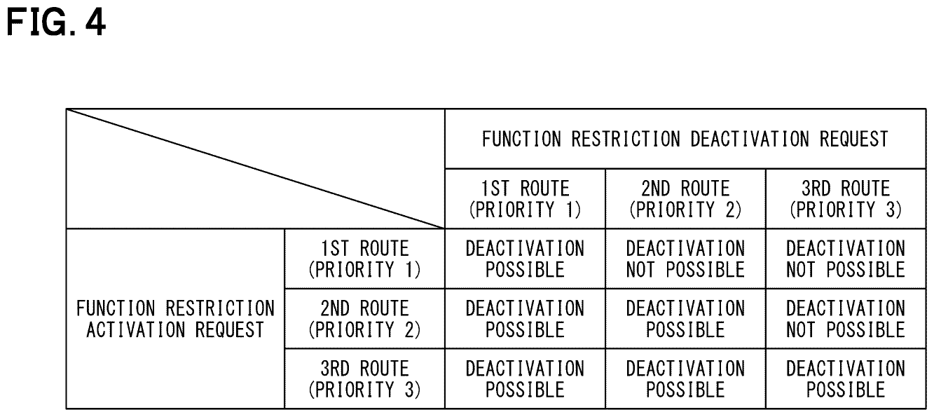

As shown in FIG. 4, the deactivation possibility determination unit 17e determines whether the activated function restriction can be deactivated by comparing the priority of function restriction deactivation request with the priority of function restriction activation request. When the deactivation possibility determination unit 17e determines that the priority of function restriction deactivation request is higher than the priority of function restriction activation request, or that the priority of function restriction deactivation request is equal to the priority of function restriction activation request, the deactivation possibility determination unit 17e determines that the function restriction can be deactivated. On the other hand, in response to determining that the priority of function restriction deactivation request is lower than the priority of function restriction activation request, the deactivation possibility determination unit 17e determines that the function restriction should be maintained in activated state, that is, the deactivation is not allowed.

For example, when the function restriction activation request is received via the first route and the function restriction deactivation request is also received via the first route, the deactivation possibility determination unit 17e determines that the priority of function restriction deactivation request is equal to the priority of function restriction activation request, and determines that the function restriction, which has been activated via the first route, can be deactivated. On the other hand, when the function restriction activation request is received via the first route and the function restriction deactivation request is received via the second or third route, the deactivation possibility determination unit 17e determines that the priority of function restriction deactivation request is lower than the priority of function restriction activation request, and determines the function restriction, which has been activated via the first route, cannot be deactivated. That is, when the owner of a stolen vehicle activates the function restriction via the first route, the function restriction cannot be deactivated even if the thief who stole the vehicle attempts to deactivate the function restriction via the third route.

For example, when the function restriction activation request is received via the second route and the function restriction deactivation request is received via the first route or the second route, the deactivation possibility determination unit 17e determines that the priority of function restriction deactivation request is higher than the priority of function restriction activation request or that the priority of function restriction deactivation request is equal to the priority of function restriction activation request, and determines that the function restriction, which has been activated via the second route, can be deactivated. On the other hand, when the function restriction activation request is received via the second route and the function restriction deactivation request is received via the third route, the deactivation possibility determination unit 17e determines that the priority of function restriction deactivation request is lower than the priority of function restriction activation request, and determines the function restriction, which has been activated via the second route, cannot be deactivated. That is, if the owner of a stolen vehicle activates a function restriction through the second route, the thief who stole the vehicle cannot deactivate the function restriction even if the thief attempts to deactivate the function restriction via the third route.

As described above, an owner of stolen vehicle can operate the external device 15 to activate the function restriction through the first route or the second route. Thus, even if a thief who stole the vehicle operates, in the vehicle, the operation input unit 16 to deactivate the function restriction through the third route, the activated function restriction can be continued without being deactivated, thereby minimizing damage caused by the theft. After the theft is resolved, the vehicle owner can operate the external device 15 to perform the operation for deactivating the function restriction via the first route or the second route.

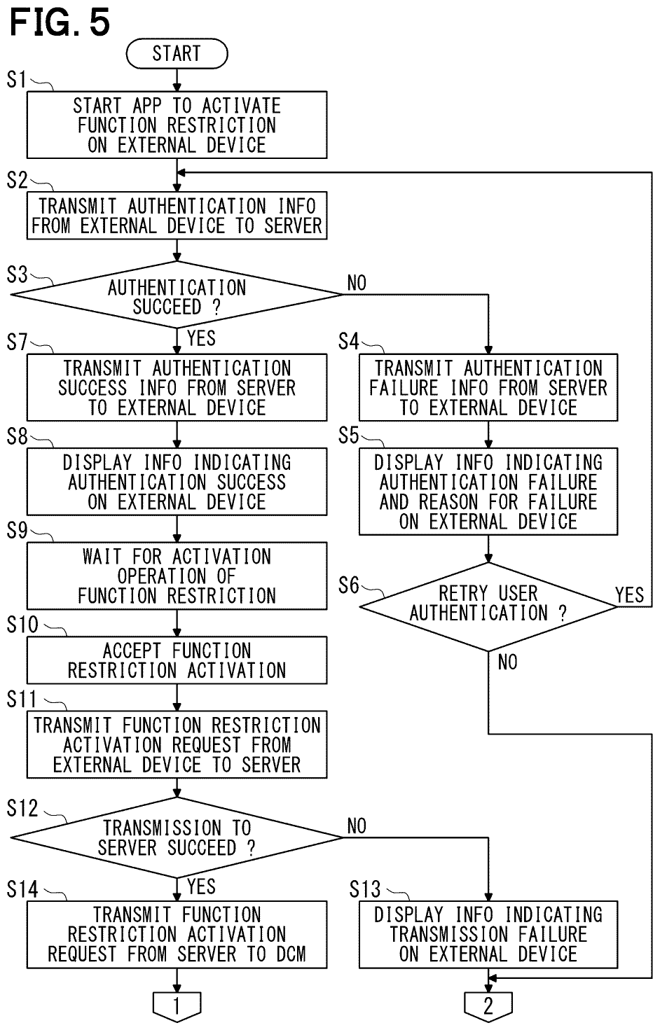

The following will describe the above-described operation with reference to FIG. 5 to 37. The following will describe function restriction activation process via the first route, the function restriction activation process via the second route, the function restriction activation process via the third route, and the function restriction deactivation process, in order.

### (1-1) Function Restriction Activation Process via First Route (See FIG. 5 to FIG. 8)

The external device 15, the server 3, and the vehicle system 2 cooperate to perform the function restriction activation process via the first route. When the vehicle owner operates the external device 15 to start an application for activating the function restriction on the external device 15, the external device 15 starts the application for activating function restriction (S1), displays a password input screen, and waits for the password input from the vehicle owner. When the vehicle owner performs an operation to input the password, the external device 15 transmits authentication information necessary for user authentication, including the password input by the vehicle owner, to the server 3 (S2).

When the server 3 receives the authentication information from the external device 15, the server 3 checks the received authentication information against pre-registered information and determines whether the authentication is successful (S3). When the server 3 determines that the authentication information does not match the pre-registered information, the server 3 determines that the authentication has failed (S3: NO). Then, the server 3 transmits, to the external device 15, authentication failure information, which indicates that the authentication has failed, together with the reason for the authentication failure (S4). When the external device 15 receives the authentication failure information from the server 3, the external device 15 displays information indicating the authentication failure together with the reason for authentication failure (S5).

The external device 15 determines whether to retry the user authentication (S6). In response to determining that the vehicle owner has performed an operation on the external device 15 to refuse the retry of user authentication or time is out since the vehicle owner did not perform any operation (S6: NO), the application for activating the function restriction is ended, and the function restriction activation process via the first route is ended.

In response to determining that the vehicle owner has performed an operation on the external device 15 to select retry of user authentication (S6: YES), the process returns to S2, and the external device 15 displays, for example, the password input screen again and waits for the password input operation from the vehicle owner. In response to the vehicle owner performing the password input operation again, the external device 15 repeats S2 and subsequent steps. The number of times that user authentication is retried may be set to a limited number. When the retry number of user authentication exceeds a predetermined number, the external device 15 may forcibly end the application that activates the function restriction and forcibly end the function restriction activation process via the first route.

When the server 3 determines that the authentication information matches the registration information and determines that the authentication is succeeded (S3: YES), the server 3 transmits, to the external device 15, authentication success information indicating that the authentication is succeeded (S7).

When the external device 15 receives the authentication success information from the server 3, the external device 15 displays information indicating that the authentication is succeeded (S8). The external device 15 displays a function restriction activation window and waits for a function restriction activation operation (S9). When the vehicle owner performs a function restriction activation operation, the external device 15 accepts the activation of function restriction activated by the operation of vehicle owner (S10), and transmits a function restriction activation request indicating the accepted function restriction activation to the server 3 (S11).

The external device 15 determines whether the transmission of function restriction activation request to the server 3 has been succeeded (S12). For example, when the external device 15 determines that a timeout has occurred without receiving a response confirmation for the function restriction activation request from the server 3 thereby determining that the transmission of function restriction activation request to the server 3 has failed (S12: NO), the external device 15 displays information indicating that the transmission of function restriction activation request has failed (S13), ends the application for activating the function restriction, and ends the function restriction activation process via the first route.

The external device 15 determines whether to retry transmission of the function restriction activation request to the server 3. In response to determining that the vehicle owner has performed an operation on the external device 15 to refuse the retry of transmitting the function restriction activation request to the server 3 or determining that time is out without the vehicle owner performing any operation, the external device 15 may end the application for activating the function restriction and end the function restriction activation process via the first route.

In response to determining that the vehicle owner has performed an operation on the external device 15 to retry the transmission of function restriction activation request to the server 3, the process may return to S9 and repeat S9 and subsequent steps. Alternatively, the retry number may be set to a limited number. When the retry number exceeds a predetermined number, the external device 15 may forcibly end the application for activating the function restriction and forcibly end the function restriction activation process via the first route.

For example, when the external device 15 determines that a response confirmation for the function restriction activation request is received from the server 3, the external device 15 can determine that the transmission of function restriction activation request to the server 3 is succeeded (S12: YES). Then, the external device 15 displays information indicating that the transmission of function restriction activation request is succeeded.

When the server 3 receives the function restriction activation request from the external device 15, the server 3 transmits the received function restriction activation request to the DCM 5, which has been associated with the external device 15 in advance (S14). The server 3 determines whether the transmission of function restriction activation request to the DCM 5 is succeeded (S15). For example, when the server 3 determines that a timeout has occurred without receiving a response confirmation for the function restriction activation request from the DCM 5, the server 3 determines that the transmission of function restriction activation request to the DCM 5 has failed (S15: NO). Then, the server 3 sends a transmission failure notification to the external device 15 indicating that the transmission of function restriction activation request has failed.

When the external device 15 receives the transmission failure notification from the server 3, the external device 15 displays information indicating that the transmission of function restriction activation request has failed (S16), and then ends the application for activating the function restriction, thereby ending the function restriction activation process via the first route. The external device 15 determines whether to retry transmission of the function restriction activation request from the server 3 to the DCM 5. In response to determining that the vehicle owner has performed an operation on the external device 15 to refuse the retry of transmitting the function restriction activation request from the server 3 to the DCM 5 or determining that time is out without the vehicle owner performing any operation, the external device 15 may end the application that activates the function restriction and end the function restriction activation process via the first route.

In response to determining that the vehicle owner has performed an operation on the external device 15 to retry the transmission of function restriction activation request from the server 3 to the DCM 5, the process may return to S11 and repeat S11 and subsequent steps. Alternatively, the retry number may be set to a limited number. When the retry number exceeds a predetermined number, the external device 15 may forcibly end the application for activating the function restriction and forcibly end the function restriction activation process via the first route.

For example, when the server 3 determines reception of a response confirmation for the function restriction activation request from the DCM 5, the server 3 determines that the transmission of function restriction activation request to the DCM 5 is succeeded (S15: YES). Then, the server 3 transmits a transmission success notification indicating that the transmission of function restriction activation request is succeeded, to the external device 15. When the external device 15 receives the transmission success notification from the server 3, the external device 15 displays information indicating that the transmission of function restriction activation request is succeeded (S17).

When the DCM 5 receives the function restriction activation request from the external device 15, the DCM 5 transmits the received function restriction activation request to the HCU 10. When the HCU 10 receives the function restriction activation request from the DCM 5, the HCU 10 transmits the received function restriction activation request to the ECU 6.

When the ECU 6 receives the function restriction activation request from the HCU 10, the ECU 6 determines whether the priority information is maintained at the reception time of the function restriction activation request (S18). When the ECU 6 determines that no priority information is maintained (S18: NO), the ECU 6 activates the function restriction according to the received function restriction activation request (S19). The process executed in S19 corresponds to a function restriction activation procedure. Then, the ECU 6 determines whether the activation of function restriction is succeeded (S20).

For example, after transmitting the function restriction activation signal to the corresponding ECU, the ECU 6 determines whether a timeout is occurred without receiving a response signal to the function restriction activation signal from the ECU. In response to determining that the activation of function restriction has failed (S20: NO), the ECU 6 transmits an activation failure notification to the external device 15 to notify that the function restriction activation has failed. When the external device 15 receives the activation failure notification from the ECU, the external device 15 displays information indicating that the function restriction activation has failed (S21), ends the application for activating the function restriction, and ends the function restriction activation process via the first route.

For example, after transmitting a function restriction activation signal to the corresponding ECU, suppose that the ECU 6 received a response signal to the function restriction activation signal from the ECU. In this case, the ECU 6 determines that the function restriction has been successfully activated (S20: YES), and transmits an activation success notification to the external device 15 to notify that the function restriction has been successfully activated. When the external device 15 receives the activation success notification from the ECU, the external device 15 displays information indicating that the function restriction has been successfully activated (S22).

The ECU 6 determines the route of the function restriction activation request. When the ECU 6 determines that the function restriction activation request is received via the first route (S23: YES), the ECU 6 sets the priority level to “1” (S24). When the ECU 6 determines that the function restriction activation request is received via the second route (S25: YES), the ECU 6 sets the priority level to “2” (S26). When the ECU 6 determines that the function restriction activation request is received via the third route (S27: YES), the ECU 6 sets the priority level to “3”(S28).

After the ECU 6 sets the priority information, the ECU 6 transmits a priority setting notification indicating that the priority information has been set to the HCU 10 and also causes the DCM 5 to transmit the priority setting notification to the server 3. When the HCU 10 receives the priority setting notification from the ECU 6, the HCU 10 causes the CID 12 and the meter device 13 to display information indicating that the priority information has been set (S29). When the server 3 receives the priority setting notification from the DCM 5, the server 3 transmits, to the external device 15, the received priority setting notification (S30). When the external device 15 receives the priority setting notification from the server 3, the external device 15 displays information indicating that the priority information has been set (S31), and ends the function restriction activation process via the first route.

When the ECU 6 determines presence of priority information (S18: YES), the ECU identifies the route via which the function restriction activation request is received (S32). Then, the ECU 6 sets the priority of identified route of the function restriction activation request as the current priority, and compares the current priority with the priority of indicated by the stored priority information (S33). When the ECU 6 determines that the current priority is higher than the priority indicated by the stored priority information (S33: YES), the ECU 6 updates the stored priority to the current priority (S34) and proceeds to S29 and subsequent steps. When the ECU 6 determines that the current priority is equal to the priority indicated by the stored priority information or the current priority is lower than the priority indicated by the stored priority information (S33: NO), the ECU6 does not update the stored priority to the current priority, and proceeds to S29 and subsequent steps.

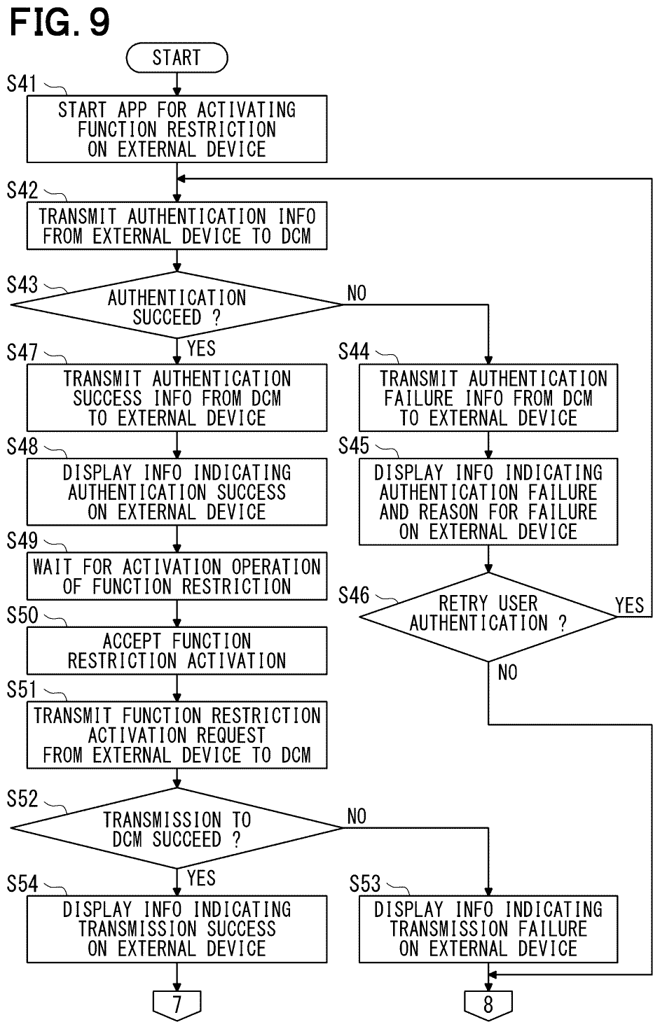

### (1-2) Function Restriction Activation Process via Second Route (See FIG. 9 to FIG. 12)

The external device 15 and the vehicle system 2 cooperate to perform the function restriction activation process via the second route. When the vehicle owner operates the external device 15 to start an application for activating the function restriction on the external device 15, the external device 15 starts the application for activating function restriction (S41), displays a password input screen, and waits for the password input from the vehicle owner. When the vehicle owner performs an operation to input the password, the external device 15 transmits authentication information necessary for user authentication, including the password input by the vehicle owner, to the DCM 5 (S42).

When the DCM 5 receives the authentication information from the external device 15, the DCM 5 transmits the received authentication information to the HCU 10. When the HCU 10 receives the authentication information from the DCM 5, the HCU 10 checks the received authentication information against pre-registered registration information and determines whether the authentication is successful (S43). When the HCU 10 determines that the authentication information does not match the pre-registered information, the HCU 10 determines that the authentication has failed (S43: NO). Then, the HCU 10 transmits, to the DCM 5, authentication failure information, which indicates that the authentication has failed, together with the reason for the authentication failure. When the DCM 5 receives the authentication failure information from the HCU 10, the DCM 5 transmits the received authentication failure information to the external device 15 (S44). When the external device 15 receives the authentication failure information from the DCM 5, the external device 15 displays information indicating the authentication failure together with the reason for authentication failure (S45).

In this case, the external device 15 also determines whether to retry the user authentication (S46). In response to determining that the vehicle owner has performed an operation on the external device 15 to refuse the retry of user authentication or time is out since the vehicle owner did not perform any operation (S46: NO), the application for activating the function restriction is ended, and the function restriction activation process via the second route is ended.

In response to determining that the vehicle owner has performed an operation on the external device 15 to select retry of user authentication (S46: YES), the external device 15 displays, for example, the password input screen again and waits for the password input operation from the vehicle owner. In response to the vehicle owner performing the password input operation again, the external device 15 returns to S42, and repeats S42 and subsequent steps. The number of times that user authentication is retried may be set to a limited number. When the retry number of user authentication exceeds a predetermined number, the external device 15 may forcibly end the application that activates the function restriction and forcibly end the function restriction activation process via the second route.

When the HCU 10 determines that the authentication information matches the registration information and determines that the authentication is succeeded (S43: YES), the HCU 10 transmits, to the DCM 5, authentication success information indicating that the authentication is succeeded (S47). When the DCM 5 receives the authentication success information from the HCU 10, the DCM 5 transmits the received authentication success information to the external device 15.

When the external device 15 receives the authentication success information from the DCM 5, the external device 15 displays information indicating that the authentication is succeeded (S48). Then, the external device 15 displays a function restriction activation window, and waits for a function restriction activation operation (S49).

When the vehicle owner performs the function restriction activation operation, the external device 15 accepts the function restriction activation by the activation operation made by the vehicle owner (S50), and transmits a function restriction activation request indicating the accepted function restriction activation to the DCM 5 (S51).

The external device 15 determines whether the transmission of function restriction activation request to the DCM 5 is succeeded (S52). When the external device 15 determines that the transmission of function restriction activation request to the DCM 5 has failed (S52: NO), the external device 15 displays information indicating that the transmission of function restriction activation request has failed (S53). Then, the external device 15 ends the application for activating the function restriction, and ends the function restriction activation process via the second route. The external device 15 determines whether to retry transmission of the function restriction activation request to the DCM 5. In response to determining that the vehicle owner has performed an operation on the external device 15 to refuse the retry of transmitting the function restriction activation request to the DCM 5 or determining that time is out without the vehicle owner performing any operation, the external device 15 may end the application for activating the function restriction and end the function restriction activation process via the second route.

In response to determining that the vehicle owner has performed an operation on the external device 15 to retry the transmission of function restriction activation request to the DCM 5, the process may return to 51 and repeat S51 and subsequent steps. Alternatively, the retry number may be set to a limited number. When the retry number exceeds a predetermined number, the external device 15 may forcibly end the application for activating the function restriction and forcibly end the function restriction activation process via the second route.

When the external device 15 determines that the transmission of function restriction activation request to the DCM 5 has been succeeded (S52: YES), the external device 15 displays information indicating that the transmission of function restriction activation request has succeeded. Then, the process in S55 to S65 is execute in a similar manner as process executed in S18 to S28 described in the function restriction activation process via the first route.

After the ECU 6 sets the priority information, the ECU 6 transmits, to the HCU 10, a priority setting notification indicating that the priority information has been set. The ECU 6 also causes the DCM 5 to transmit the priority setting notification to the external device 15. When the HCU 10 receives the priority setting notification from the ECU 6, the HCU 10 causes the CID 12 and the meter device 13 to display information indicating that the priority information has been set (S66). When the external device 15 receives the priority setting notification from the DCM 5, the external device 15 displays information indicating that the priority information has been set (S67), and ends the function restriction activation process via the second route.

When the ECU 6 determines the presence of priority information (S55: YES), the process executes S68 to S70 in a similar manner as S32 to S34 executed in the function restriction activation process via the first route.

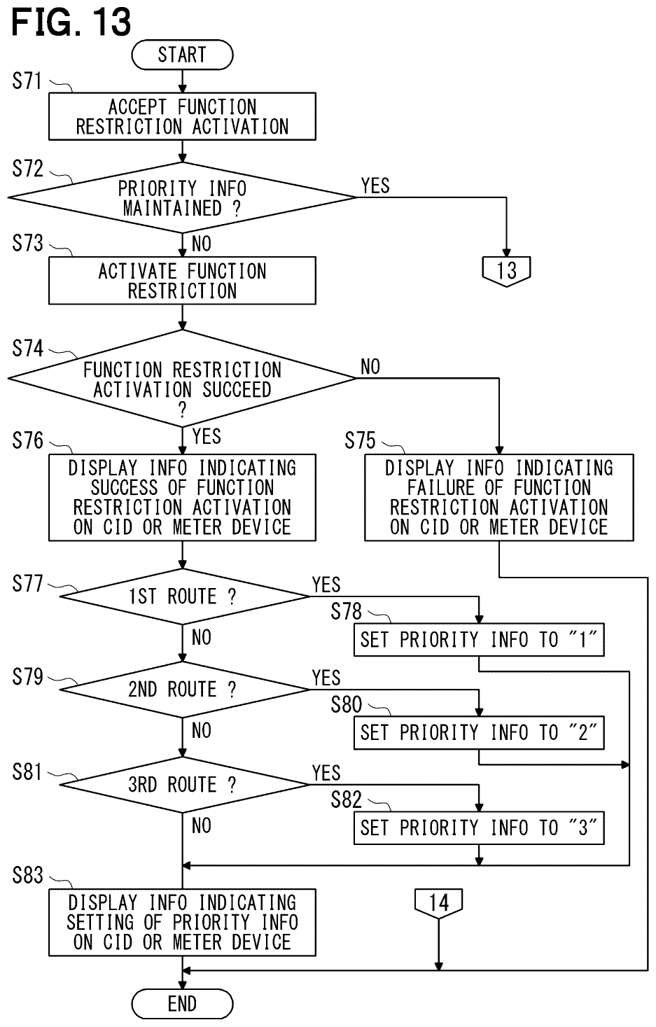

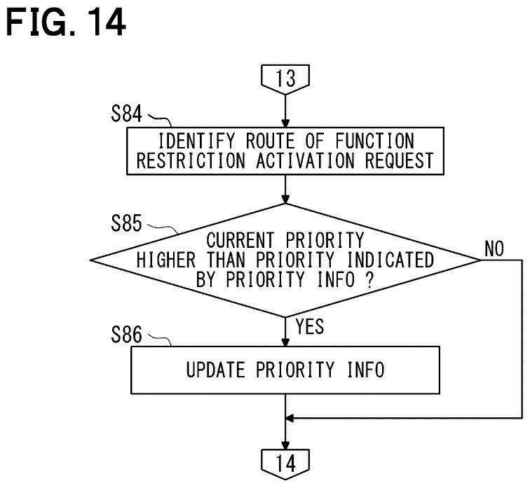

### (1-3) Function Restriction Activation Process via Third Route (See FIG. 13 and FIG. 14)

The vehicle system 2 is able to perform the function restriction activation process via the third route by itself. When the operation input unit 16 accepts the function restriction activation by the activation operation made by the vehicle owner (S71), the operation input unit 16 transmits a function restriction activation request indicating the accepted function restriction activation to the HCU 10. When the HCU 10 receives the function restriction activation request from the operation input unit 16, the HCU 10 transmits the received function restriction activation request to the ECU 6. Then, the process in SS72 to S82 is execute in a similar manner as process executed in S18 to S28 described in the function restriction activation process via the first route. In this case, when the ECU 6 determines failure of function restriction activation (S74: NO), the ECU 6 transmits, to the HCU 10, an activation failure notification indicating that the function restriction activation has failed. When the HCU 10 receives the activation failure notification from the ECU 6, the HCU 10 causes the CID 12 and the meter device 13 to display information indicating that activation of function restriction has failed (S75). When the ECU 6 determines that the function restriction has been successfully activated (S74: YES), the ECU 6 transmits, to the HCU 10, an activation success notification indicating that the function restriction has been successfully activated. When the HCU 10 receives the activation success notification from the ECU, the HCU 10 causes the CID 12 and the meter device 13 to display information indicating that the activation of function restriction has been succeeded (S76).

After the ECU 6 sets the priority information, the ECU 6 transmits, to the HCU 10, a priority setting notification indicating that the priority information has been set. When the HCU 10 receives the priority setting notification from the ECU 6, the HCU 10 causes the CID 12 and the meter device 13 to display the priority information that has been set (S83), and ends the function restriction activation process via the third route.

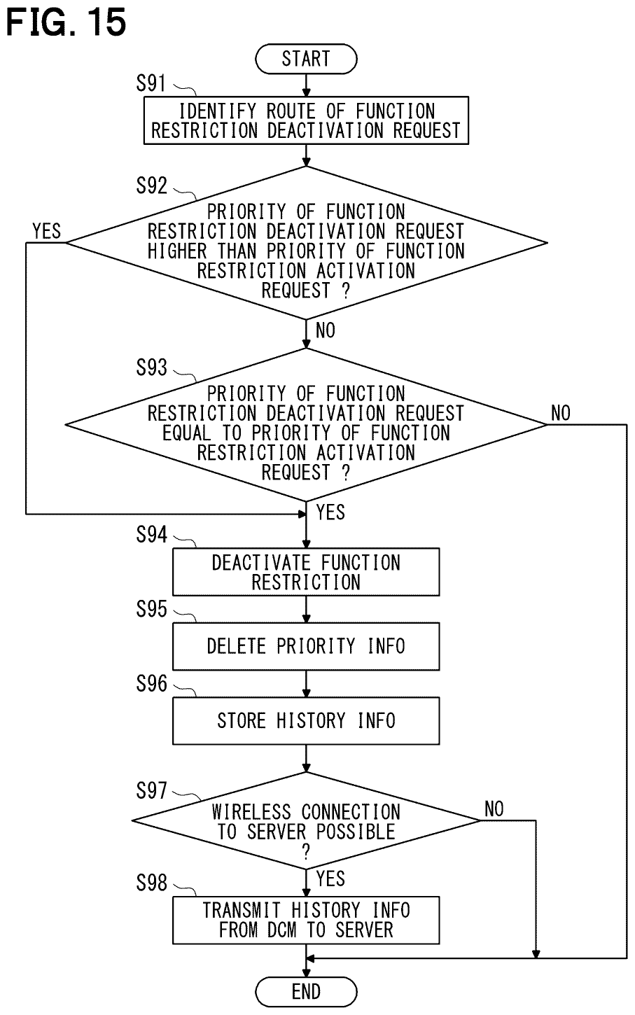

When the ECU 6 determines the presence of priority information (S72: YES), the ECU 6 executes S84 to S86 in a similar manner as the process executed in S32 to S34 as described in the function restriction activation process via the first route. S(1-4) Function Restriction Deactivation Process (see FIG. 15)

The ECU 6 identifies the route via which the function restriction deactivation request is received (S91), and compares the priority of identified route via which the function restriction deactivation request is received with the priority of route via which the function restriction activation request is received (S92, S93). The process executed in S92 and S94 corresponds to a deactivation possibility determination procedure. When the ECU 6 determines that the priority of route via which the function restriction deactivation request is received is higher than the priority of route via which the function restriction activation request is received (S92: YES), or determines that the priority of route via which the function restriction deactivation request is received is equal to the priority of route via which the function restriction activation request is received (S93: YES), the ECU 6 deactivates the function restriction (S94). the process executed in S94 corresponds to a function restriction deactivation procedure. The ECU 6 deletes the priority information (S95), and stores history information indicating that the function restriction has been deactivated (S96).

The ECU 6 determines whether the DCM 5 can be wirelessly connected to the server 3 (S97). When the ECU 6 determines that the DCM 5 can be wirelessly connected to the server 3 (S97: YES), the ECU 6 wirelessly connects the DCM 5 to the server 3, causes the DCM 5 to transmit the history information to the server 3 (S98), and ends the function restriction deactivation process.

On the other hand, when the ECU 6 determines that the priority of route via which the function restriction deactivation request is received is lower than the priority of route via which the function restriction activation request is received (S92: NO and S93: NO), the ECU 6 does not deactivate the function restriction, does not delete the priority information, and ends the function restriction deactivation process. As described above, the priority of route via which the function restriction deactivation request is received is compared with the priority of route via which the function restriction activation request is received to determine whether to deactivate the function restriction. Thus, in a case where the owner of a stolen vehicle operates the external device 15 to activate the function restriction via the first route or the second route and then the thief who stole the vehicle operates the operation input unit 16 to deactivate the function restriction via the third route, the activated function restriction can be continued without being deactivated with the above-described configuration.

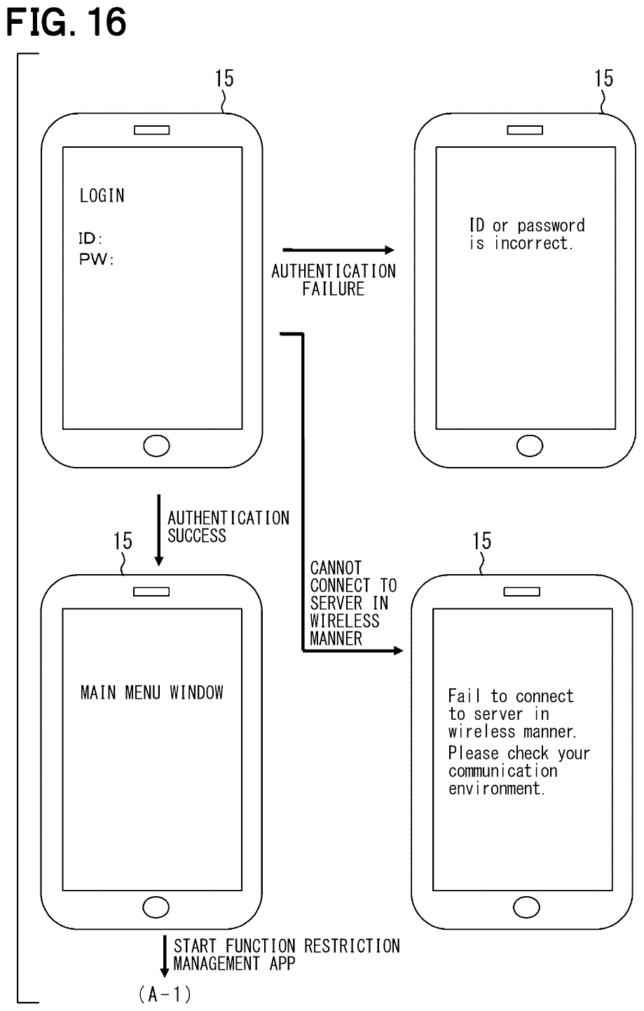

The following will describe a transition of display with reference to FIG. 16 to FIG. 37. Here, the transition of display accompanying the activation of function restriction via each route and the transition of display accompanying the deactivation of function restriction via each route will be described.

### (1) Transition of Display Accompanying Activation of Function Restriction via the First Route (See FIG. 16 to FIG. 19)

The external device 15 waits for the user to manually input an ID and password while displaying the login screen, and performs authentication in response to receiving the ID and password. If the authentication fails, the external device 15 displays a message, such as “ID or password is incorrect.” When the external device 15 fails to connect to the server 3 in wireless manner, the external device 15 displays a message, such as “Fail to connect to server in wireless manner. Please check your communication environment.”

When the authentication is succeeded, the external device 15 displays a main menu screen. When the function restriction management application is started, the external device 15 displays a message, such as “Activate function restriction?” and waits for an operation input from the user. When the external device 15 receives an operation input indicating activation of function restriction from the user by pressing the “YES” button, the external device 15 displays a message, such as “Function restriction activation in progress.”

When the external device 15 fails to activate the function restriction due to a failure in wireless connection to the server 3, the external device 15 displays a message, such as “Fail to connect to server in wireless manner. Activation of function restriction failed.” Wen the external device 15 fails to activate the function restriction due to the failure in wireless connection between the server 3 and the DCM 5, the external device 15 displays a message, such as “Fail to connect to DCM in wireless manner. Activation of function restriction failed.” When the external device 15 fails to activate the function restriction due to an access error to the HCU 10 in the vehicle system 2, the external device 15 displays a message, such as “An error has occurred in the vehicle system. Activation of function restriction failed.” When the external device 15 fails to activate the function restriction because the function restriction has already been activated, the external device 15 displays a message, such as “Function restriction has already been activated.”

When the external device 15 has successfully activated the function restriction, the external device 15 displays a message, such as “Function restriction is activated. If you want to deactivate the function restriction, please perform a deactivation operation.” The HCU 10 may further display a message, such as “A registered terminal has instructed activation of function restriction. Function restriction has been activated” on the CID 12. For example, when a function restriction on a navigation function is activated, the HCU 10 changes the navigation screen from normal display to a grayed-out display. When an icon indicating the function for which the function restriction has been activated is displayed, the HCU 10 may erase the icon. When a speed restriction is activated, the HCU 10 may display a message, such as “Speed has been restricted to XX km/h.” When the map screen is displayed while driving, for example, graying out the map screen may affect driving of the vehicle. Thus, the HCU 10 activates function restriction on destination setting, route guidance, viewing of registered addresses, or the like. However, display of the map screen may be continued without applying function restriction on the display of map screen.

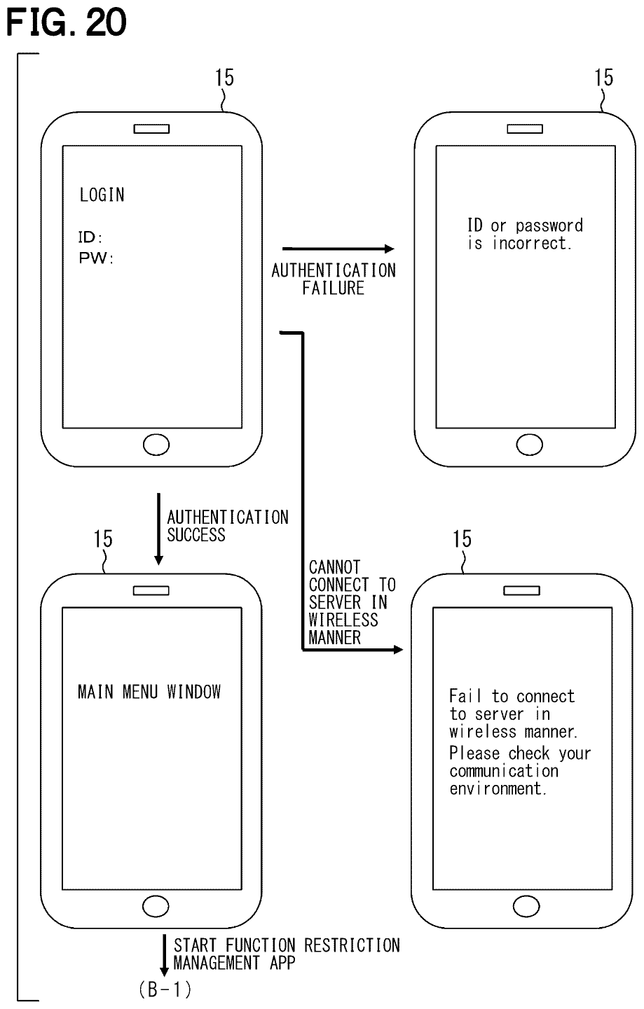

### (2) Transition of Display Accompanying Deactivation of Function Restriction via the First Route (See FIG. 20 to FIG. 23)

The external device 15 waits for the user to manually input an ID and password while displaying the login screen, and performs authentication in response to receiving the ID and password. When the external device 15 fails to authenticate the user, the external device 15 displays a message, such as “ID or password is incorrect.”. When the external device fails to connect wirelessly to the server 3, the external device 15 displays a message, such as “Fail to connect to server in wireless manner. Please check your communication environment.”When the authentication is succeeded, the external device 15 displays a main menu screen. When the function restriction management application is started, the external device 15 displays a message, such as “Deactivate function restriction?” and waits for an operation input from the user. When the external device 15 receives an operation input indicating deactivation of function restriction from the user by pressing the “YES” button, the external device 15 displays a message, such as “Function restriction deactivation in progress.”When the external device 15 fails to deactivate the function restriction due to a failure in wireless connection to the server 3, the external device 15 displays a message, such as “Fail to connect to the server in wireless manner. Deactivation of function restriction failed.” When the external device 15 fails to deactivate the function restriction due to the failure in wireless connection between the server 3 and the DCM 5, the external device 15 displays a message, such as “Fail to connect to DCM in wireless manner. Deactivation of function restriction failed.” When the external device 15 fails to deactivate the function restriction due to an access error to the HCU 10 in the vehicle system 2, the external device 15 displays a message, such as “An error has occurred in the vehicle system. Deactivation of function restriction failed.” When the external device 15 fails to deactivate the function restriction because the function restriction has already been deactivated, the external device 15 displays a message, such as “Function restriction has already been deactivated.”

When the external device 15 has successfully deactivated the function restriction, the external device 15 displays a message, such as “Function restriction is deactivated. If you want to activate the function restriction, please perform an activation operation.” The HCU 10 may further display a message, such as “A registered terminal has instructed deactivation of function restriction. Function restriction has been deactivated” on the CID 12. For example, when a function restriction on a navigation function is deactivated, the HCU 10 changes the navigation screen from a grayed-out display to a normal display. When an icon indicating the function for which the function restriction has been deactivated is not displayed, the HCU 10 may display the icon again. When a speed restriction is deactivated, the HCU 10 may display a message, such as “Speed restriction has been removed.”

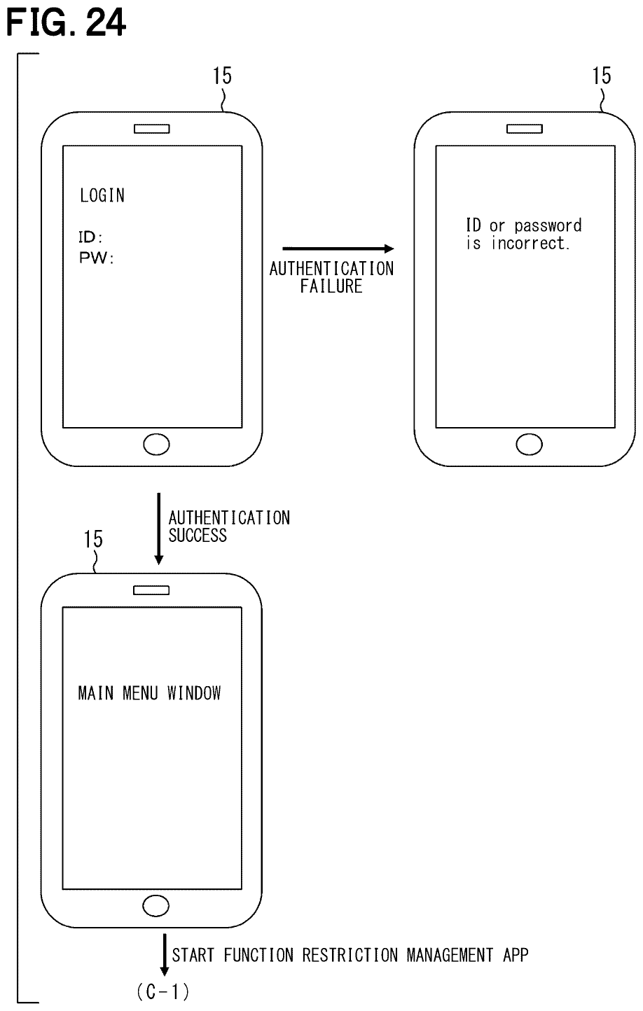

### (3) Transition of Display Accompanying Activation of Function Restriction via the Second Route (See FIG. 24 to FIG. 27)

In this case, the process related to the server 3 is omitted from the description of “(1) Transition of display accompanying activation of function restriction via the first route”described above, and the remaining process is the same.

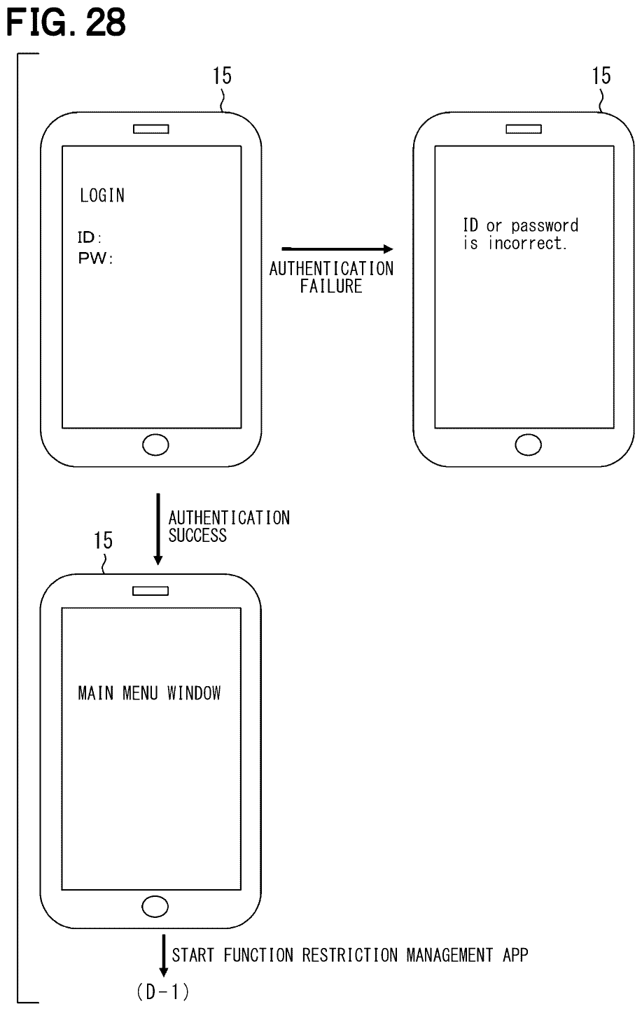

### (4) Transition of Display Accompanying Deactivation of Function Restriction via the Second Route (See FIG. 28 to FIG. 31)

In this case, the process related to the server 3 is omitted from the description of “(2) Transition of display accompanying deactivation of function restriction via the first route” described above, and the remaining process is the same.

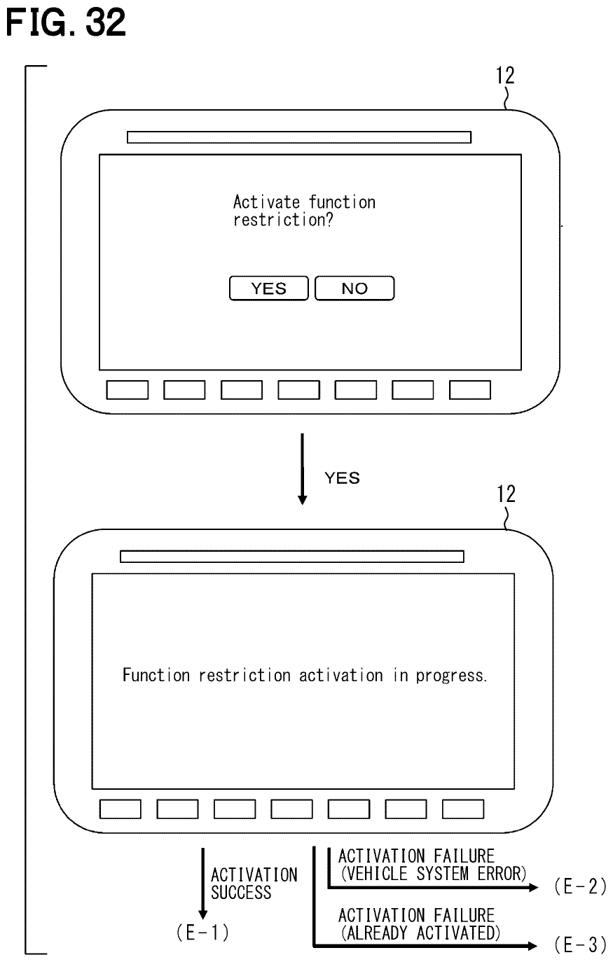

### (5) Transition of Display Accompanying Activation of Function Restriction via the Third Route (See FIG. 32 to FIG. 34)

The HCU 10 displays a message, such as “Activate function restriction?” on the CID 12 and waits for an operation to be input from the operation input unit 16. In response to “YES” button being pressed and the operation input unit 16 receives an operation input indicating activation of function restriction, the HCU 10 causes the CID 12 to display a message, such as “Function restriction activation in progress.”

When the HCU 10 fails to activate the function restriction due to an access error to the HCU 10 in the vehicle system 2, the HCU 10 displays, on the CID 12, a message, such as “An error has occurred in the vehicle system. Activation of function restriction failed.” When the HCU 10 fails to activate the function restriction because the function restriction has already been activated, the HCU 10 displays, on the CID 12, a message, such as “Function restriction has already been activated.”

When the HCU 10 has successfully activated the function restriction, the HCU 10 displays, on the CID 12, a message, such as “Function restriction is activated. If you want to deactivate the function restriction, please perform a deactivation operation.” In this case, similar to the above-described “(1) Transition of display accompanying activation of function restriction via the first route”, when a function restriction on a navigation function is activated, the HCU 10 changes the navigation screen from normal display to a grayed-out display. When an icon indicating the function for which the function restriction has been activated is displayed, the HCU 10 may erase the icon. When a speed restriction is activated, the HCU 10 may display a message, such as “Speed has been restricted to XX km/h.”

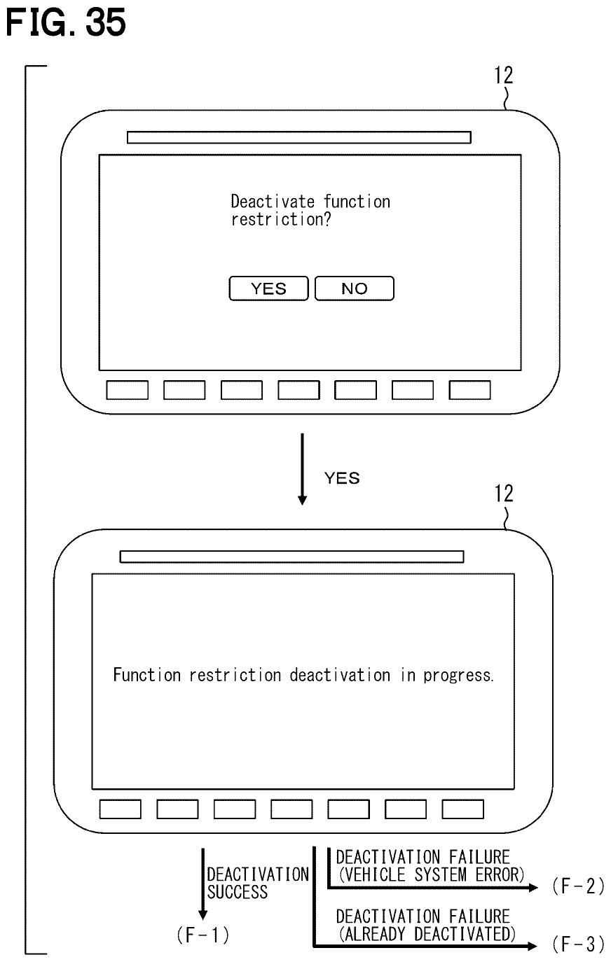

### (6) Transition of Display Accompanying Deactivation of Function Restriction via the Third Route (See FIG. 35 to FIG. 37)

The HCU 10 displays a message, such as “Deactivate function restriction?” on the CID 12 and waits for an operation to be input from the operation input unit 16. In response to “YES” button being pressed and the operation input unit 16 receives an operation input indicating deactivation of function restriction, the HCU 10 causes the CID 12 to display a message, such as “Function restriction deactivation in progress.”

When the HCU 10 fails to deactivate the function restriction due to an access error to the HCU 10 in the vehicle system 2, the HCU 10 displays, on the CID 12, a message, such as “An error has occurred in the vehicle system. Deactivation of function restriction failed.” When the HCU 10 fails to deactivate the function restriction because the function restriction has already been deactivated, the HCU 10 displays, on the CID 12, a message, such as “Function restriction has already been deactivated.”

When the HCU 10 has successfully deactivated the function restriction, the HCU 10 displays, on the CID 12, a message, such as “Function restriction is deactivated. If you want to activate the function restriction, please perform an activation operation.” For example, when a function restriction on a navigation function is deactivated, the HCU 10 changes the navigation screen from a grayed-out display to a normal display. When an icon indicating the function for which the function restriction has been deactivated is not displayed, the HCU 10 may display the icon again. When a speed restriction is deactivated, the HCU 10 may display a message, such as “Speed restriction has been removed.”

The ECU 6 may store the date and time when the function restriction is activated or deactivated as history information in association with the route via which the activation or deactivation is performed. The history information may be displayed on the external device 15 or the CID 12. For example, a display performed outside the vehicle and a display performed inside the vehicle, for example, a display on the external device 15 and a display on the CID 12 may be synchronized with one another. When the function restriction is activated or deactivated via the first route or the second route by operating the external device 15, this operation can be notified to the CID 12. When the function restriction is activated or deactivated via the third route by operating the operation input unit 16, this operation can be notified to the external device 15. It may also be possible to select whether to synchronize the display on the external device 15 with the display on the CID 12. The notification indicating that the function restriction has been activated or deactivated may be performed in a different manner. For example, a display by an indicator on the meter device 13 may be used instead of or in addition to the display on the external device 15 and the CID 12. Instead of or in addition to the notification by display, notification by audio output may be performed.

According to the above-described first embodiment, the following operational effects can be obtained. The ECU 6 determines whether the function restriction can be deactivated based on the priority of route, and deactivates the function restriction in response to determining that the function restriction can be deactivated. By setting the priority for determining whether the function restriction can be deactivated, it is possible to prevent a situation in which the thief who stole a vehicle can deactivate the function restriction, which has been activated by the owner of the stolen vehicle. With this configuration, the intended effect of function restriction activated against vehicle theft can be appropriately obtained.

The priority is set according to the operation type for activating or deactivating the function restriction. Whether the function restriction can be deactivated is determined based on the priority set according to the operation type. By associating the operation type with the priority, it is possible to determine whether to deactivate the function restriction by determining the operation type.

The priorities are set for the first route, which is an operation performed via the wireless communication from the external device 15 via the communication network 4, the second route, which is an operation performed via the short-range wireless communication from the external device 15, and the third route, which is an operation from the operation input unit 16. By determining whether the operation is performed via the first route, the second route, or the third route, it is possible to determine whether the function restriction can be deactivated.

In the present disclosure, the priority is configured to be updated. For example, after activating the function restriction by performing the activation operation via the second route, activating the function restriction by performing the activation operation via the first route, the accuracy of authentication can be increased and a situation in which the function restriction is deactivated by a thief who has stolen the vehicle can be effectively and appropriately avoided.

Whether the function restriction can be deactivated is determined by comparing the priority of function restriction activation request corresponding to each route against the priority of function restriction deactivation request corresponding to each route. By assigning a priority to the function restriction activation request for each route and a priority to the function restriction activation request for each route, it is possible to determine whether to deactivate the function restriction.

When (i) the priority of function restriction deactivation request is higher than the priority of function restriction activation request or (ii) the priority of function restriction deactivation request is equal to the priority of function restriction activation request, it is determined that the function restriction can be deactivated. When the priority of function restriction deactivation request is lower than the priority of function restriction activation request, it is determined that the function restriction cannot be deactivated. For example, when the owner of a stolen vehicle activates the function restriction using the first or second route, the effect of activated function restriction can be properly achieved since the activated function restriction cannot be deactivated even if the thief who stole the vehicle attempts to deactivate the function restriction via the third route in the vehicle.

### Second Embodiment

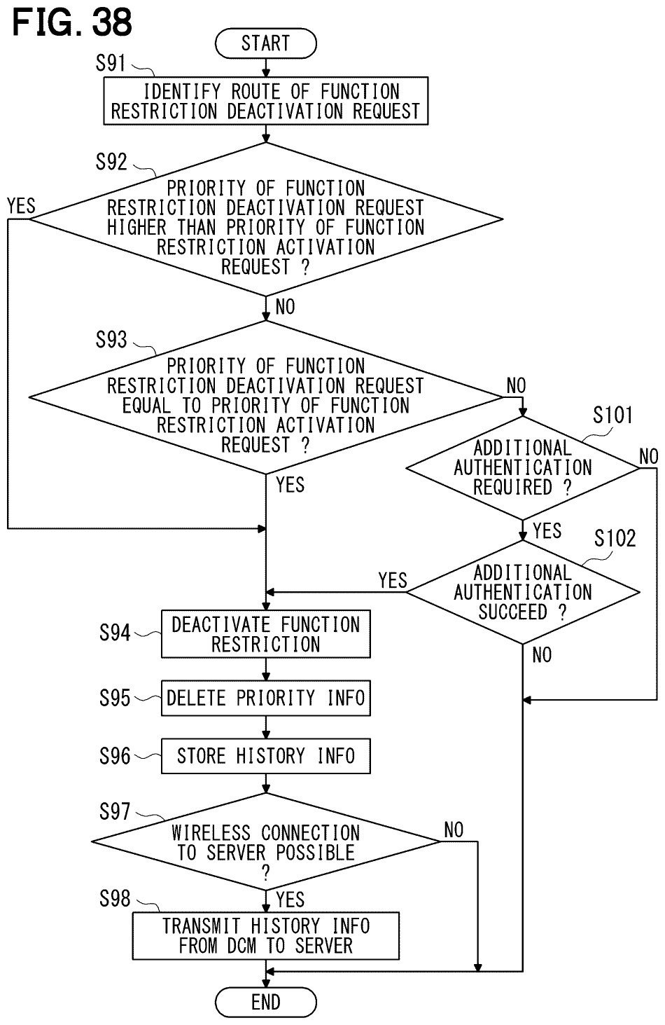

The following will describe a second embodiment of the present disclosure with reference to FIG. 38. The second embodiment differs from the first embodiment in that additional authentication is performed even when the priority of route via which the function restriction deactivation request is received is lower than the priority of route via which the function restriction activation request is received.

### (2-1) Function Restriction Deactivation Process (See FIG. 38)

When the ECU 6 determines that the priority of route via which the function restriction deactivation request is received is lower than the priority of route via which the function restriction activation request is received (S92: NO, S93: NO), the ECU 6 determines whether additional authentication, for example by password input, is required (S101). When the ECU 6 determines that additional authentication is not required (S101: NO), the ECU 6 ends the function restriction deactivation process. When the ECU 6 determines that additional authentication is required (S101: YES), the ECU 6 determines whether the additional authentication is successful (S102). When the ECU 6 determines that the additional authentication has failed (S102: NO), the ECU 6 ends the function restriction deactivation process. When the ECU 6 determines that the additional authentication has succeeded (S102: YES), the ECU 6 proceeds to S94 and subsequent steps.

In other words, even if the priority of route via which the function restriction deactivation request is received is lower than the priority of route via which the function restriction activation request is received, under a condition that the ECU 6 determines that the additional authentication is succeeded, the ECU 6 deactivates the function restriction in the same way as when the ECU 6 determines that the priority of route via which the function restriction deactivation request is received is higher than or equal to the priority of route via which the function restriction activation request is received. The additional authentication may be, for example, implemented by one-time password.

According to the present embodiment described above, the following operational effects can be obtained. In the ECU 6, even when the priority of route via which the function restriction deactivation request is received is lower than the priority of route via which the function restriction activation request is received, the function restriction is deactivated on the condition that the additional authentication is successful. For example, even when a request to deactivate the function restriction is received via a route with a lower priority than the function restriction activation request due to an operation mistake by the vehicle owner, the function restriction can be deactivated under a condition that the additional authentication is successful.

### Third Embodiment

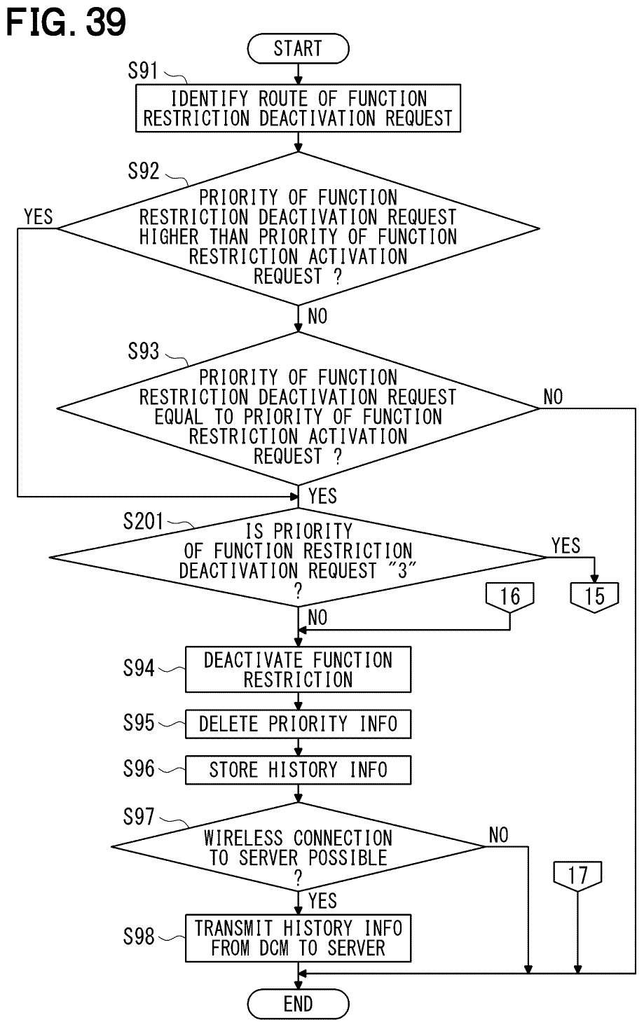

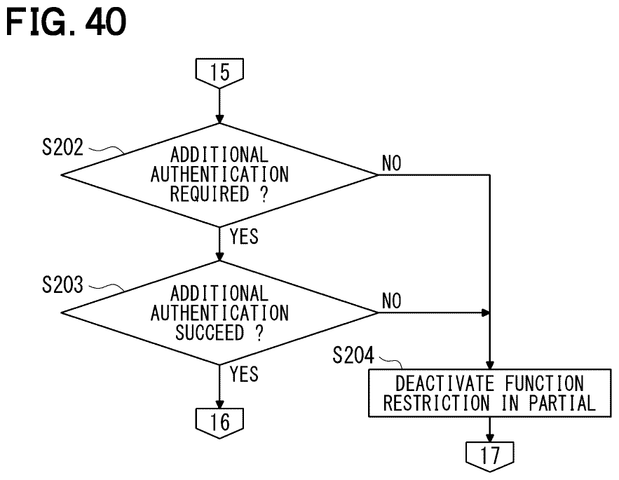

The following will describe a third embodiment with reference to FIG. 39 and FIG. 40. The third embodiment differs from the first embodiment in that additional authentication is required when the priority of route via which the function restriction activation request is received is “3.”

### (3-1) Function Restriction Deactivation Process (See FIG. 39 and FIG. 40)

When the ECU 6 determines that the priority of route via which the function restriction deactivation request is received is higher than the priority of route via which the function restriction activation request is received (S92 YES), or when the ECU 6 determines that the priority of route via which the function restriction deactivation request is received is equal to the priority of route via which the function restriction activation request is received (S93: YES), the ECU 6 determines whether the priority of route via which the function restriction activation request is received is equal to “3” (S201). When the ECU 6 determines that the priority of route via which the function restriction activation request is received is not equal to “3” (S201: NO), the ECU 6 proceeds to S94 and subsequent steps.

When the ECU 6 determines that the priority of route via which the function restriction activation request is received is equal to “3” (S201: YES), the ECU 6 determines whether the additional authentication, such as password entry, is required (S202). When the ECU 6 determines that additional authentication is not required (S202: NO), the ECU 6 deactivates the function restriction in a limited manner (S204), and ends the function restriction deactivation process. Deactivating the function restriction in a limited manner means deactivating the function restriction and then activating the function restriction after elapse of a certain time period, deactivating the function restriction and then activating the function restriction in response to the number of times by which the function has been used reaches a predetermined number of times, or deactivating a part of the function restriction, for example, deactivating function restriction that is not related to driving of vehicle while maintaining function restriction that is related to the driving of vehicle.

When the ECU 6 determines that additional authentication is necessary (S202: YES), the ECU 6 determines whether the additional authentication has been succeeded (S203). When the ECU 6 determines that the additional authentication has failed (S203: NO), the ECU 6 also deactivates the function restriction partially, that is, in a limited manner (S204) and ends the function restriction deactivation process. When the ECU 6 determines that the additional authentication has succeeded (S203: YES), the ECU 6 proceeds to S94 and subsequent steps.

When the priority of route via which the function restriction deactivation request is received is higher than or equal to the priority of route via which the function restriction activation request is received and the priority of route via which the function restriction deactivation request is received is “3”, the ECU 6 deactivates the function restriction in a limited manner in response to (i) determining that additional authentication is not required, (ii) determining that additional authentication is required but the additional authentication has failed. In response to determining that the additional authentication has succeeded, the function restriction is completely deactivated instead of deactivating in a limited manner. In this case, the additional authentication may be implemented by one-time password.

According to the above-described third embodiment, the following operational effects can be obtained. In the ECU 6, when the function restriction is deactivated by an operation input from the operation input unit 16, the function restriction is deactivated on the condition that the additional authentication is successful. By setting the additional authentication, the function restriction properly activated by the activation operation can be prevented from being deactivated unconditionally by the deactivation operation performed via the third route. Thus, a situation in which the function restriction is deactivated by a thief who has stolen the vehicle can be effectively and appropriately avoided. When the vehicle owner properly performs the additional authentication, the function restriction can be properly deactivated.

In the ECU 6, when the function restriction is deactivated by the deactivation operation input from the operation input unit 16, if additional authentication is not required or if additional authentication has failed, the function restriction is deactivated in a limited manner. By deactivating the function restriction in a limited manner, even if a thief who has stolen a vehicle is able to deactivate the function restriction, the damage caused by deactivation of the function restriction can be reduced by setting the condition.

### Other Embodiments

While the present disclosure has been described based on the above embodiments, the present disclosure is not limited to the embodiments or structures described herein. The present disclosure includes various modification examples and equivalents thereof. Various combinations and configurations, as well as other combinations and configurations including more, less, or only a single element, are within the scope and spirit of the present disclosure.

The controller and the method thereof described in the present disclosure may be implemented by a dedicated computer provided by configuring a processor and a memory programmed to execute one or more functions embodied by a computer program. Alternatively, the controller and the method thereof described in the present disclosure may be implemented by a dedicated computer provided by configuring a processor with one or more dedicated hardware logic circuits. Alternatively, the controller and the method described in the present disclosure may be implemented by one or more dedicated computers including the combination of a processor programmed to execute one or more functions and a memory and a processor including one or more hardware logic circuits. The computer program may be stored in a computer-readable non-transitory tangible storage medium as instructions to be executed by a computer.

What is claimed is:

1. An electronic control device comprising:
at least one of (i) a circuit and (ii) a processor with a memory storing computer program code executable by the processor, the at least one of the circuit and the processor configured to cause the electronic control device to:
activate a function restriction against vehicle theft;
set a priority based on an operation type corresponding to an activation operation or a deactivation operation of the function restriction;
maintain the set priority;
update the maintained priority when a current priority indicated by a function restriction activation request is higher than the maintained priority;
determine, based on the priority, whether the activated function restriction can be deactivated; and
deactivate the function restriction, which has been activated, in response to determining that the function restriction can be deactivated.

2. The electronic control device according to claim 1, wherein the at least one of the circuit and the processor is further configured to
set the priority based on the operation type, which includes (i) an operation made via communication between an external device and the electronic control device through a communication network, (ii) an operation made via communication between the external device and the electronic control device through a short-range wireless communication or a wired communication, and (iii) an operation input by an operation input unit.

3. The electronic control device according to claim 1, wherein the at least one of the circuit and the processor is further configured to
determine whether the function restriction, which has been activated, can be deactivated by comparing (i) a priority of the function restriction activation request corresponding to the operation type with (ii) a priority of a function restriction deactivation request corresponding to the operation type.

4. The electronic control device according to claim 3, wherein the at least one of the circuit and the processor is further configured to
determine that the function restriction can be deactivated in response to determining that (i) the priority of the function restriction deactivation request is higher than the priority of the function restriction activation request or (ii) the priority of the function restriction deactivation request is equal to the priority of the function restriction activation request.

5. The electronic control device according to claim 3, wherein the at least one of the circuit and the processor is further configured to
determine that the function restriction cannot be deactivated in response to determining that the priority of the function restriction deactivation request is lower than the priority of the function restriction activation request.

6. The electronic control device according to claim 3, wherein the at least one of the circuit and the processor is further configured to
determine that the function restriction can be deactivated in response to an authentication result indicating authentication success even when the priority of the function restriction deactivation request is lower than the priority of the function restriction activation request.

7. The electronic control device according to claim 2, wherein the at least one of the circuit and the processor is further configured to
deactivate the function restriction under a condition that an authentication result indicates authentication success when the deactivation operation for deactivating the function restriction is input by the operation input unit.

8. The electronic control device according to claim 2, wherein the at least one of the circuit and the processor is further configured to
deactivate the function restriction in a limited manner when the deactivation operation for deactivating the function restriction is input by the operation input unit.

9. The electronic control device according to claim 1, wherein the at least one of the circuit and the processor is further configured to
notify a user of a determination result indicating that the activated function restriction cannot be deactivated together with a reason why the function restriction cannot be deactivated in response to determining that the function restriction cannot be deactivated.

10. A function restriction management system comprising:
an electronic control device mounted on a vehicle;
an external device; and
an operation input unit,
wherein the electronic control device includes:
a function restriction activation unit configured to activate a function restriction against vehicle theft;
a priority setting unit configured to set a priority based on an operation type corresponding to an activation operation or a deactivation operation of the function restriction;
a priority maintaining unit configured to maintain the priority set by the priority setting unit;
a priority update unit configured to update the priority maintained by the priority maintaining unit when a current priority indicated by a function restriction activation request is higher than the priority maintained by the priority maintaining unit;
a deactivation possibility determination unit configured to determine, based on the priority, whether the function restriction activated by the function restriction activation unit can be deactivated; and
a function restriction deactivation unit configured to deactivate the function restriction, which has been activated by the function restriction activation unit, in response to the deactivation possibility determination unit determining that the function restriction can be deactivated, and
the priority setting unit is configured to set the priority based on the operation type, which includes (i) an operation made via communication between the external device and the electronic control device through a communication network, (ii) an operation made via communication between the external device and the electronic control device through a short-range wireless communication or a wired communication, and (iii) an operation input by the operation input unit.

11. A function restriction management method executed at least one processor of an electronic control device mounted on a vehicle, the function restriction management method comprising:
activating a function restriction against vehicle theft;
setting a priority based on an operation type corresponding to an activation operation or a deactivation operation of the function restriction;
maintaining the set priority;
updating the maintained priority when a current priority indicated by a function restriction activation request is higher than the maintained priority;
determining, based on the priority, whether the activated function restriction can be deactivated; and
deactivating the function restriction, which has been activated, in response to determining that the activated function restriction can be deactivated.

12. A non-transitory computer readable storage medium storing function restriction management program comprising instructions configured to, when executed by at least one processor of an electronic control device mounted on a vehicle, cause the at least one processor to:
activate a function restriction against vehicle theft;
set a priority based on an operation type corresponding to an activation operation or a deactivation operation of the function restriction;
maintain the set priority;
update the maintained priority when a current priority indicated by a function restriction activation request is higher than the maintained priority;
determine, based on the priority, whether the activated function restriction can be deactivated; and
deactivate the function restriction, which has been activated, in response to determining that the function restriction can be deactivated.
